(19) United States
(12) Patent Application Publication
(10) Pub. No.: US 2026/0308815 A1
(43) Pub. Date: Oct. 8, 2026

(54) TREATMENT AGENT FOR ACRYLIC FIBERS AND USE OF THE SAME

(71) Applicant: Matsumoto Yushi-Seiyaku Co., Ltd., Yao-shi, Osaka (JP)

(72) Inventors: Ikko KOZAKI, Yao-shi, Osaka (JP); Toshihiko KIKUTA, Yao-shi, Osaka (JP)

(73) Assignee: Matsumoto Yushi-Seiyaku Co., Ltd., Yao-shi, Osaka (JP)

(21) Appl. No.: 19/100,736

(22) PCT Filed: Jul. 28, 2023
(86) PCT No.: PCT/JP2023/027680

§ 371 Date: Feb. 3, 2025

(30) Foreign Application Priority Data
Sep. 13, 2022 (JP) 2022-145018

(51) Int. Cl. D01F 11/06; C01B 32/05; C08K 3/32; C08K 5/09; C08K 5/101; C08K 5/31; C08K 5/46; C08K 5/521; C09D 7/20; C09D 7/45; C09D 7/61; C09D 7/63; C09D 183/08; D01F 6/18; D01F 9/22

(52) U.S. Cl. CPC D01F 11/06; C01B 32/05; C09D 7/20; C09D 7/45; C09D 7/61; C09D 7/63; C09D 183/08; D01F 6/18; D01F 9/225; C08K 2003/329; C08K 5/09; C08K 5/101; C08K 5/31; C08K 5/46; C08K 5/521; D10B 2401/04

(57) ABSTRACT

A treatment agent for acrylic fibers includes an amino-modified silicone (A), and at least one selected from a compound (B) having a five-membered ring structure containing a sulfur atom and a nitrogen atom and a derivative of the compound (B). Also disclosed are acrylic fibers for carbon fiber production using the treatment agent, and a method for producing carbon fibers using the treatment agent. The acrylic fibers for carbon fiber production is provided by attaching the treatment agent for acrylic fibers to raw material acrylic fibers of the acrylic fibers for carbon fiber production. The treatment agent for acrylic fibers is capable of improving the bundling property of acrylic fibers for carbon fiber production in the step for enhancing flame resistance of acrylic fibers for carbon fiber production.

### CROSS-REFERENCE TO RELATED APPLICATIONS

This application is a National Stage of International Application No. PCT/JP2023/027680 filed Jul. 28, 2023, claiming priority from Japanese Patent Application No. 2022-145018 filed Sep. 13, 2022.

### BACKGROUND OF THE INVENTION

### Field of the Invention

The present invention relates to a treatment agent for acrylic fibers and a use thereof. More specifically, the present invention relates to a treatment agent used in production of acrylic fibers, acrylic fibers (hereinafter, they may be referred to as a precursor) for carbon fiber production using the treatment agent, and a method for producing carbon fibers using the treatment agent.

### Description of the Related Art

Carbon fibers are widely used in aerospace applications, sports applications, general industrial applications, and the like as reinforcing fibers for composite materials with plastics called matrix resins because of their excellent mechanical properties.

As a method for producing carbon fibers, first, acrylic fibers (sometimes referred to as a precursor) for carbon fiber production are produced (this process for producing a precursor is sometimes referred to as a yarn making process). A common method is to convert this precursor into flame resistant fibers in an oxidizing atmosphere at 200 to 300° C. (hereinafter this step may be referred to as a flame resistance enhancing treatment step), followed by carbonization in an inert atmosphere at 300 to 2,000° C. (this step may be hereinafter referred to as a carbonization treatment step) (hereinafter the flame resistance enhancing treatment step and the carbonization treatment step may be collectively referred to as a calcination step). This precursor is produced through a stretching step in which the precursor is stretched at a higher ratio than for normal acrylic fibers. At this time, sticking of fibers easily occurs, and high magnification stretching is not uniformly performed, so that a non-uniform precursor is obtained. Carbon fibers obtained by calcination of such a precursor has the problem that sufficient strength cannot be obtained. In addition, there is the problem that single fibers are fused to each other during calcination of the precursor, and the quality and grade of the obtained carbon fibers are deteriorated.

In order to prevent sticking of a precursor and prevent fusion of carbon fibers, many techniques have been proposed in which a silicone-based treatment agent having a low friction between fibers in a wet state and in a high-temperature environment and an amino-modified silicone-based treatment agent capable of improving the anti-fusion property are applied to the precursor as treatment agents to be applied to the precursor (see Patent Literatures 1 and 2).
Patent Literature 1: JP 2001-172879 A
Patent Literature 2: JP 2002-129481 A

### Problems to be Solved by the Invention

However, when the treatment for enhancing flame resistance is performed using the precursor to which such treatment agents have been applied, there is the problem that the bundling property of the precursor is deteriorated due to the peeling action and the friction-lowering action between fibers by silicone. Therefore, in the flame resistance enhancing treatment step and the carbonization treatment step, disturbance of fiber bundles and stretching unevenness due to the insufficient bundling property may occur, leading to deterioration of workability, process passability, and quality of carbon fibers.

### SUMMARY OF THE INVENTION

Therefore, an object of the present invention is to provide a treatment agent for acrylic fibers capable of improving the bundling property of acrylic fibers for carbon fiber production in the step for enhancing flame resistance of acrylic fibers for carbon fiber production, acrylic fibers for carbon fiber production using the treatment agent, and a method for producing carbon fibers using the treatment agent.

As a result of intensive studies to solve the above problems, the present inventors have discovered that a treatment agent for acrylic fibers containing an amino-modified silicone (A) and at least one selected from a compound (B) having a five-membered ring structure containing a sulfur atom and a nitrogen atom and a derivative of the compound (B) can improve the bundling property of a precursor in a step for enhancing flame resistance of acrylic fibers for carbon fiber production, and have achieved the invention of the present application.

That is, the treatment agent for acrylic fibers of the present invention includes the following embodiments.

<1> A treatment agent for acrylic fibers, including: an amino-modified silicone (A); and at least one selected from a compound (B) having a five-membered ring structure containing a sulfur atom and a nitrogen atom and a derivative of the compound (B).

<2> The treatment agent for acrylic fibers according to <1>, in which the compound (B) contains at least one selected from a compound represented by General Formula (1) below and a compound represented by General Formula (2) below.

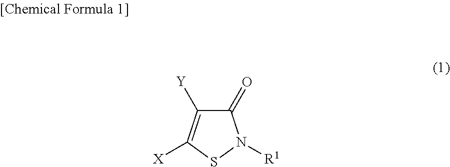

In Formula (1), R¹ is an alkyl group having 1 to 12 carbon atoms, an aralkyl group, or a hydrogen atom, and X and Y are independently a hydrogen atom or a halogen atom.

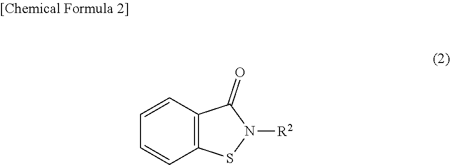

In Formula (2), R² is an alkyl group having one to eight carbon atoms or a hydrogen atom.

<3> The treatment agent for acrylic fibers according to <1> or <2>, further including a Bronsted acid compound (C).

<4> The treatment agent for acrylic fibers according to <3>, in which the Bronsted acid compound (C) contains at least one selected from a carboxylic acid compound, an inorganic acid, a sulfonic acid compound, a phosphate ester compound, a sulfate ester compound, and a phosphonic acid compound.

<5> The treatment agent for acrylic fibers according to <3> or <4>, in which a molar ratio of the Bronsted acid compound (C) to amino groups of the amino-modified silicone (A) is 0.01 to 5.0.

<6> The treatment agent for acrylic fibers according to any one of <3> to <5>, in which a total weight of the compound (B) and the derivative of the compound (B) is 0.01 to 50 parts by weight with respect to 100 parts by weight of the Bronsted acid compound (C).

<7> The treatment agent for acrylic fibers according to any one of <1> to <6>, further including a hydrophilic solvent (D), in which the hydrophilic solvent (D) contains at least one selected from a compound represented by General Formula (3) below and an aprotic nitrogen-containing organic compound.

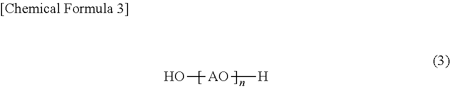

In Formula (3), AO is an oxyalkylene group having two to four carbon atoms, and n is an integer of one to three.

<8> The treatment agent for acrylic fibers according to any one of <1> to <7>, in which a weight ratio of the amino-modified silicone (A) to a non-volatile content of the treatment agent is 20 to 90 wt %.

<9> The treatment agent for acrylic fibers according to any one of <1> to <8>, further including a nonionic surfactant (E).

<10> An acrylic fiber for carbon fiber production, including the treatment agent for acrylic fibers according to any one of <1> to <9> attached to a raw material acrylic fiber of the acrylic fiber for carbon fiber production.

<11> A method for producing a carbon fiber, the method including: a flame resistance enhancing treatment step of converting the acrylic fiber for carbon fiber production according to <10> into a flame resistant fiber in an oxidizing atmosphere at 200 to 300° C.; and a carbonization treatment step of further carbonizing the flame resistant fiber in an inert atmosphere at 300 to 2,000° C.

### Advantageous Effects of the Invention

When the acrylic fibers for carbon fiber production produced by adding the treatment agent for acrylic fibers of the present invention are used, the treatment agent can improve the bundling property in the step for enhancing flame resistance of the acrylic fibers for carbon fiber production, and can ameliorate the disturbance of fiber bundles and stretching unevenness associated with the insufficient bundling property. When the acrylic fibers for carbon fiber production of the present invention are used, the fiber bundle disturbance and stretching unevenness can be ameliorated by improving the bundling property in the flame resistance enhancing treatment step, and the workability and process passability can be improved. According to the method for producing carbon fibers of the present invention, disturbance of fiber bundles and stretching unevenness are ameliorated by improving the bundling property, workability and process passability are improved, and high-quality carbon fibers can be obtained.

### DETAILED DESCRIPTION OF PREFERRED EMBODIMENTS

The treatment agent of the present invention are specifically described as follows. However, the present invention should not be construed as being limited thereto.

Each component of a treatment agent for acrylic fibers of the present invention will be described.

### [Amino-Modified Silicone (A)]

The treatment agent of the present invention contains an amino-modified silicone (A). The amino group (including an organic group having an amino group), which is a modification group of the amino-modified silicone, may be bonded to a side chain of silicone, which is a main chain, may be bonded to a terminal, or may be bonded to both. However, from the viewpoint of fiber protection in the flame resistance enhancing treatment step, it is preferable that the amino group be bonded to the side chain (there is an amino group on the side chain). In addition, the amino group may be any of a monoamine type, a diamine type, and a polyamine type, which may coexist in one molecule, but the monoamine type or the diamine type is preferable from the viewpoint of uniformly applying the treatment agent to the inside of the fiber bundle in the flame resistance enhancing treatment step and forming a film of the treatment agent to protect the fibers. The amino-modified silicone may contain an amino polyether-modified silicone. The amino polyether-modified silicone is a silicone having at least one amino group and a polyether group in the structure.

A kinematic viscosity of the amino-modified silicone (A) at 25° C. is preferably 50 to 20,000 mm²/s from the viewpoint of uniform adhesion to the fibers, the scattering suppressing property of the treatment agent, and the imparting of the bundling property to the fibers. The upper limit of the kinematic viscosity is more preferably 15,000 mm²/s, still more preferably 10,000 mm²/s, particularly preferably 8,000 mm²/s. On the other hand, the lower limit of the kinematic viscosity is more preferably 100 mm²/s, still more preferably 150 mm²/s, particularly preferably 200 mm²/s. Furthermore, for example, 200 to 10,000 mm²/s is more preferable, and 200 to 8,000 mm²/s is still more preferable.

An amino equivalent of the amino-modified silicone (A) is preferably 300 to 10,000 g/mol from the viewpoint of preventing sticking and fusion between fibers. The upper limit of the amino equivalent is more preferably 9,500 g/mol, still more preferably 9,000 g/mol, particularly preferably 8,000 g/mol. On the other hand, the lower limit of the amino equivalent is more preferably 500 g/mol, still more preferably 1,000 g/mol, particularly preferably 1,500 g/mol. Furthermore, for example, 500 to 9,000 g/mol is more preferable, and 1,000 to 8,000 g/mol is still more preferable.

Here, the amino equivalent means the mass of the siloxane skeleton per amino group or ammonium group. The unit represented as g/mol is a value converted into a value per 1 mol of an amino group or an ammonium group. Therefore, a smaller amino equivalent value indicates a higher ratio of amino groups or ammonium groups in the molecule.

As the amino-modified silicone (A), a plurality of amino-modified silicones having different amino equivalents and kinematic viscosities (25° C.) may be used in combination. When two or more types of amino-modified silicones are used, the amino equivalent means the amino equivalent of the entire amino-modified silicones (mixture), and the kinematic viscosity at 25° C. means the kinematic viscosity of the entire amino-modified silicones (mixture).

Examples of the amino-modified silicone include a compound represented by General Formula (4) below.

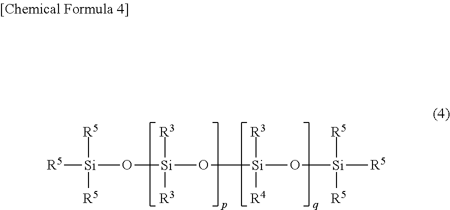

In Formula (4), R³ represents an alkyl group or an aryl group having 1 to 20 carbon atoms. R⁴ is a group represented by General Formula (5) below. R⁵ is R³, R⁴, or —OR¹¹ (R¹¹ is a hydrogen atom or an alkyl group having 1 to 6 carbon atoms). p is 5≤p≥10,000, and q is 0≤q≤1,000. However, when q=0, at least one of Ros is a group represented by General Formula (5) below.

In Formula (4), R³ is an alkyl group or an aryl group having 1 to 20 carbon atoms. R³ is preferably an alkyl group or an aryl group having 1 to 10 carbon atoms, more preferably an alkyl group having 1 to 5 carbon atoms, still more preferably a methyl group. A plurality of R³s in Formula (4) may be the same or different from each other. R⁴ is a group represented by General Formula (5) below. R⁵ is a group represented by R³, R⁴ or —OR¹¹, and is preferably R³. A plurality of R¹¹s in Formula (4) may be the same or different from each other.

R¹¹ is a hydrogen atom or an alkyl group having 1 to 6 carbon atoms, preferably a hydrogen atom or an alkyl group having 1 to 4 carbon atoms, more preferably a hydrogen atom or a methyl group. p is a number of 5 to 10,000, preferably 30 to 5,000, more preferably 50 to 2,000. q is a number of 0 to 1,000, preferably 0.1 to 500, more preferably 0.2 to 100.

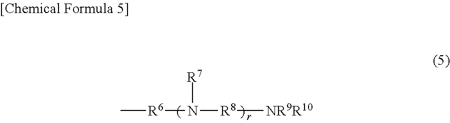

In Formula (5), R⁶ and R⁸ each independently represent an alkylene group having 1 to 6 carbon atoms, preferably an alkylene group having 1 to 3 carbon atoms. R⁷, R⁹, and R¹⁰ each independently represent a hydrogen atom, an alkyl group or an aryl group having 1 to 10 carbon atoms, preferably a hydrogen atom or an alkyl group having 1 to 5 carbon atoms, more preferably a hydrogen atom. r is a number of zero to six, preferably zero to three, more preferably zero to one.

### [Compound (B) Having Five-Membered Ring Structure Containing Sulfur Atom and Nitrogen Atom, and Derivative of Compound (B)]

The treatment agent of the present invention includes at least one selected from a compound (B) having a five-membered ring structure containing a sulfur atom and a nitrogen atom (hereinafter also referred to as the compound (B)) and a derivative of the compound (B).

The compound (B) is not particularly limited as long as it is a compound having a five-membered ring structure containing a sulfur atom and a nitrogen atom, but from the viewpoint of improving the bundling property of fiber bundles using the treatment agent in the step for enhancing flame resistance, it is preferable to have a bond between heteroatoms in the five-membered ring in order to further promote the crosslinking reaction of the amino-modified silicone (A) and enhance the bundling property of fiber bundles, it is preferable to have a nitrogen-sulfur bond in the five-membered ring in order to further promote the crosslinking reaction and enhance the bundling property of fiber bundles, and it is particularly preferable to contain at least one selected from compounds represented by General Formulas (1) and (2) below in order to further promote the crosslinking reaction and enhance the bundling property of fiber bundles.

The derivative of the compound (B) is not particularly limited as long as it is a derivative of the compound (B), and examples thereof include a product in which the compound (B) forms a salt and a reaction product between the compound (B) and a compound having nucleophilicity.

It is considered that the reason why the bundling property of the fiber bundles is further improved is that when a bond between heteroatoms is present in the five-membered ring structure, the bond between heteroatoms is cleaved by heat, and the radical generated by the cleavage further promotes the crosslinking reaction of the amino-modified silicone (A). It is considered that the cleavage of a bond between heteroatoms is further promoted when the heteroatom bond has a nitrogen-sulfur bond, and the cleavage of a bond between heteroatoms is particularly promoted when the compound is a compound represented by General Formula (1) below or General Formula (2) below. It is considered that the reason why the derivative of the compound (B) further improves the bundling property of the fiber bundle is that the derivative is decomposed by heat, and the radicals generated by the decomposition promote the crosslinking reaction of the amino-modified silicone (A).

The compound (B) may contain one kind or two or more kinds and more preferably contains two or more kinds from the viewpoint of excellent abrasion resistance.

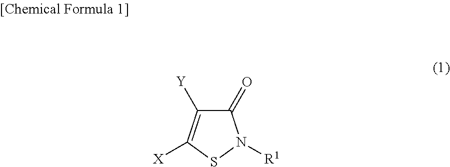

In Formula (1), R¹ is preferably an alkyl group having 1 to 12 carbon atoms, an aralkyl group, or a hydrogen atom, and X and Y are preferably independently a hydrogen atom or a halogen atom from the viewpoint of exhibiting the effect of the present application.

R¹ is more preferably an alkyl group having 1 to 10 carbon atoms, an aralkyl group, or a hydrogen atom, particularly preferably an alkyl group having one to eight carbon atoms or a hydrogen atom.

Specific examples of R¹ include a methyl group, an ethyl group, an isopropyl group, a propyl group, a butyl group, a pentyl group, a hexyl group, a heptyl group, an octyl group, a nonyl group, a decyl group, an undecyl group, a dodecyl group, a phenyl group, and a hydrogen atom. From the viewpoint of compatibility with the amino-modified silicone, a methyl group, an ethyl group, an isopropyl group, a propyl group, a butyl group, a pentyl group, a hexyl group, a heptyl group, an octyl group, a nonyl group, a decyl group, or a hydrogen atom is more preferable, and a methyl group, an ethyl group, an isopropyl group, a propyl group, a butyl group, a pentyl group, a hexyl group, a heptyl group, an octyl group, or a hydrogen atom is particularly preferable.

In Formula (1), X and Y are more preferably each independently a hydrogen atom, a chlorine atom, or a bromine atom, still more preferably a hydrogen atom or a chlorine atom.

When at least one of X and Y is a hydrogen atom, R¹ is more preferably a methyl group, an ethyl group, an isopropyl group, a propyl group, a butyl group, a pentyl group, a hexyl group, a heptyl group, an octyl group, a nonyl group, a decyl group, or a hydrogen atom from the viewpoint of compatibility with the amino-modified silicone, and is still more preferably a methyl group, an ethyl group, an isopropyl group, a propyl group, a butyl group, a pentyl group, a hexyl group, a heptyl group, an octyl group, or a hydrogen atom.

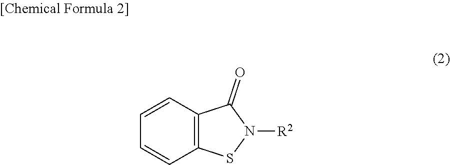

In Formula (2), R² is preferably an alkyl group having one to eight carbon atoms or a hydrogen atom from the viewpoint of exhibiting the effects of the present application, more preferably an alkyl group having one to six carbon atoms or a hydrogen atom, particularly preferably an alkyl group having one to four carbon atoms.

Specific examples of R² include a methyl group, an ethyl group, an isopropyl group, a propyl group, a butyl group, a pentyl group, a hexyl group, a heptyl group, an octyl group, and a hydrogen atom. From the viewpoint of compatibility with the amino-modified silicone, a methyl group, an ethyl group, an isopropyl group, a propyl group, a butyl group, a pentyl group, a hexyl group, or a hydrogen atom is more preferable, and a methyl group, an ethyl group, an isopropyl group, a propyl group, a butyl group, or a hydrogen atom is particularly preferable.

Examples of the compound (B) include thiazoles and thiadiazoles in addition to the compounds represented by General Formulas (1) and (2).

Examples of the thiazoles include 4-bromothiazole, 4-methylthiazole, 2,4-dichlorothiazole, 2-methyl-4-methylthiazole, 2-isopropyl-4-methylthiazole, 2-methyl-4-methylthiazole, 2-mercaptothiazole, 2-aminothiazole, 2-methylthiazole, 2-ethylthiazole, 2-propionylthiazole, 2-acetylthiazole, 5-methylthiazole, 2,5-dibromothiazole, and 5-(2-hydroxyethyl)-4-methylthiazole.

Examples of the thiadiazoles include 2-amino-1,3,4-thiadiazole, 1,3,4-thiadiazole-2-thiol, 1,3,4-thiadiazole-2,5-diamine, 2-amino-5-mercapto-1,3,4-thiadiazole, and 5-methyl-1,3,4-thiadiazole-2-thiol.

Examples of a salt of the compound (B), which is a derivative of the compound (B), include a sodium salt, a potassium salt, a calcium salt, and an amine salt. Examples of the nucleophilic compound that forms the derivative of the compound (B) include a compound having at least one selected from a thiol group, an amino group, and an alkoxy group, and specific examples thereof include an organic thiol compound, an organic amine compound, an organic alcohol compound, and an amino acid compound. Examples of these organic groups include an alkyl group, an alkenyl group, and an aryl group.

### [Bronsted Acid Compound (C)]

The treatment agent for acrylic fibers of the present invention preferably contains a Bronsted acid compound (C) from the viewpoint of suppressing the decomposition over time of the compound (B) and the derivative of the compound (B) and improving the carbon fiber strength. The Bronsted acid compound (C) refers to a proton donor, and examples thereof include a carboxylic acid compound, an inorganic acid, a sulfonic acid compound, a phosphate ester compound, a sulfate ester compound, and a phosphonic acid compound.

The carboxylic acid compound refers to a compound having a carboxy group in the molecular structure. The carboxylic acid compound is not particularly limited, and examples thereof include aliphatic monocarboxylic acids, alkyl ether carboxylic acids, aliphatic polycarboxylic acids, aromatic monocarboxylic acids, aromatic polycarboxylic acids, and amino acids.

Examples of the aliphatic monocarboxylic acids include acetic acid, lactic acid, butyric acid, crotonic acid, valeric acid, caproic acid, enanthic acid, caprylic acid, pelargonic acid, capric acid, lauric acid, myristic acid, myristoleic acid, pentadecanoic acid, palmitic acid, palmitoleic acid, isocetylic acid, margaric acid, stearic acid, isostearic acid, oleic acid, elaidic acid, vaccenic acid, linoleic acid, linolenic acid, arachidic acid, isoeicosanoic acid, gadoleic acid, eicosenoic acid, docosanoic acid, isodocosanoic acid, erucic acid, tetracosanoic acid, isotetracosanoic acid, nervonic acid, cerotic acid, montanic acid, and melissic acid.

Examples of the alkyl ether carboxylic acid include a compound in which the alkyl group has 8 to 18 carbon atoms and 1 to 50 mol of a polyoxyalkylene is added. Examples of the alkyl group include an octyl group, a nonyl group, a decyl group, an undecyl group, a dodecyl group, a tridecyl group, an isotridecyl group, a tetradecyl group, a pentadecyl group, a hexadecyl group, a heptadecyl group, and an octadecyl group. Examples of the polyoxyalkylene group include a polyoxyethylene group, a polyoxypropylene group, and a polyoxypolypropylene group.

Examples of the aliphatic polycarboxylic acids include oxalic acid, malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, and derivatives thereof.

Examples of the aromatic monocarboxylic acids include benzoic acid, cinnamic acid, naphthoic acid, toluic acid, and derivatives thereof.

Examples of the aromatic polycarboxylic acids include phthalic acid, isophthalic acid, terephthalic acid, trimellitic acid and pyromellitic acid, and derivatives thereof.

The amino acids are compounds having both an amino group and a carboxy group in the molecular structure, and examples thereof include alanine, valine, leucine, isoleucine, phenylalanine, tryptophan, methionine, proline, glycine, tyrosine, serine, threonine, cysteine, asparagine, glutamine, lysine, arginine, histidine, aspartic acid, and glutamic acid.

The inorganic acid refers to an acid containing a non-metal atom as a component. Examples of the inorganic acid include sulfuric acid, nitric acid, phosphoric acid, and hydrochloric acid.

Examples of the sulfonic acid compound include alkylbenzene sulfonic acids, polyoxyalkylene alkyl ether sulfonates, higher fatty acid amide sulfonates, alkyl sulfate monoesters, and polyoxyalkylene sulfate monoesters.

Examples of the phosphate ester compound include alkyl phosphate monoesters, alkyl phosphate diesters, polyoxyalkylene alkyl ether phosphate monoesters, polyoxyalkylene alkyl ether phosphate diesters, polyoxyalkylene alkyl phenyl ether phosphate monoesters, and polyoxyalkylene alkyl phenyl ether phosphate diesters.

Examples of the sulfate ester compound include alkyl sulfate esters, polyoxyalkylene alkyl sulfate esters, alkylphenyl sulfate esters, and polyoxyalkylene alkylphenyl sulfate esters.

Examples of the phosphonic acid compound include alkylphosphonic acids, aromatic phosphonic acids, and polyoxyalkylene alkyl ether phosphonic acids.

The pKa of the Bronsted compound (C) is preferably 0 to 7, more preferably 1 to 6.5, still more preferably 2 to 6 from the viewpoint of corrosion and safety of equipment and suppression of crosslinking over time caused by the amino groups of the amino-modified silicone.

From the viewpoint of suppressing the decomposition over time of the compound (B) and the derivative of the compound (B), the Bronsted acid compound (C) preferably contains at least one selected from a carboxylic acid compound, a phosphate ester compound, and an inorganic acid, more preferably contains at least one selected from lactic acid, an alkyl ether carboxylic acid, a phosphate ester compound, phosphoric acid, and acetic acid, and still more preferably contains at least one selected from an alkyl ether carboxylic acid, a phosphate ester compound, acetic acid, and phosphoric acid. The Bronsted acid compound (C) may be used singly or in combination of two or more kinds thereof.

### [Hydrophilic Solvent (D)]

The treatment agent for acrylic fibers of the present invention preferably contains a hydrophilic solvent (D) from the viewpoint of improving the compatibility between the amino-modified silicone (A), and the compound (B) and the derivative of the compound (B) and from the viewpoint of improving the carbon fiber strength.

The hydrophilic solvent (D) is not particularly limited as long as it has a solubility in water at 25° C. of 0.05 g/ml or more, but it is more preferable to contain at least one selected from a compound represented by General Formula (3) below and an aprotic nitrogen-containing organic compound. The hydrophilic solvent (D) may be used singly or in combination of two or more kinds thereof.

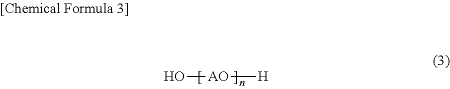

In Formula (3), AO is an oxyalkylene group having two to four carbon atoms, and n is an integer of one to three.

The compound represented by General Formula (3) is preferably at least one selected from ethylene glycol, diethylene glycol, triethylene glycol, propylene glycol, dipropylene glycol, and tripropylene glycol, more preferably at least one selected from ethylene glycol, diethylene glycol, and propylene glycol, from the viewpoint that the compatibility between the amino-modified silicone (A) and the compound (B) or the derivative of the compound (B) is improved, and the effects of the present application are more easily obtained. The compound represented by General Formula (3) may be used singly or in combination of two or more kinds thereof.

The aprotic nitrogen-containing organic compound is preferably at least one selected from N, N-dimethylformamide, 1-methyl-2-pyrrolidone, N, N-dimethylacetamide, and acetonitrile, more preferably at least one selected from 1-methyl-2-pyrrolidone and N, N-dimethylformamide, from the viewpoint of improving compatibility between the amino-modified silicone (A) and the compound (B) or the derivative of the compound (B). The aprotic nitrogen-containing organic compound may be used singly or in combination of two or more kinds thereof.

### [Treatment Agent for Acrylic Fibers]

The treatment agent for acrylic fibers of the present invention contains the amino-modified silicone (A) and at least one selected from the compound (B) and the derivative of the compound (B), and may further contain at least one selected from the Bronsted acid compound (C) and the hydrophilic solvent (D).

The reason why the bundling property of acrylic fibers is improved by causing the treatment agent for acrylic fibers of the present invention to contain the amino-modified silicone (A) and at least one selected from the compound (B) and the derivative of the compound (B) is considered to be that the crosslinking reaction of the amino-modified silicone (A) in the step for enhancing flame resistance is moderately promoted by the compound (B) or the derivative of the compound (B) to increase the molecular weight and viscosity of the amino-modified silicone in a well-balanced manner.

A total weight ratio of the compound (B) and the derivative of the compound (B) in the non-volatile content of the treatment agent of the present invention is preferably 0.001 to 1 wt % from the viewpoint of promoting the crosslinking reaction of the amino-modified silicone in the step for enhancing flame resistance. The upper limit of the weight ratio is more preferably 0.5 wt %, still more preferably 0.1 wt %, particularly preferably 0.07 wt %, most preferably 0.04 wt %. On the other hand, the lower limit of the weight ratio is more preferably 0.005 wt %, still more preferably 0.008 wt %, particularly preferably 0.01 wt %, most preferably 0.02 wt %. The weight ratio is, for example, more preferably 0.005 to 0.5 wt %, still more preferably 0.008 to 0.04 wt %.

A weight ratio of the amino-modified silicone (A) to the non-volatile content of the treatment agent of the present invention is preferably 20 to 90 wt % from the viewpoint of imparting a high bundling property to the fiber bundle. The upper limit of the weight ratio is more preferably 85 wt %, still more preferably 80 wt %. On the other hand, the lower limit of the weight ratio is more preferably 30 wt %, still more preferably 40 wt %, particularly preferably 50 wt %. The weight ratio is, for example, more preferably 40 to 90 wt %, particularly preferably 50 to 90 wt %.

A total weight of the compound (B) and the derivative of the compound (B) is preferably 0.001 to 5 parts by weight with respect to 100 parts by weight of the amino-modified silicone (A) from the viewpoint of promoting the crosslinking reaction of the amino-modified silicone in the step for enhancing flame resistance. The upper limit of the weight is more preferably 1.0 parts by weight, still more preferably 0.5 parts by weight, particularly preferably 0.25 parts by weight. On the other hand, the lower limit of the weight is more preferably 0.003 parts by weight, still more preferably 0.005 parts by weight, particularly preferably 0.007 parts by weight. The weight is, for example, more preferably 0.003 to 0.5 parts by weight, particularly preferably 0.003 to 0.25 parts by weight.

When the treatment agent of the present invention further contains the Bronsted acid compound (C), a molar ratio of the Bronsted acid compound (C) to the amino groups of the amino-modified silicone (A) is preferably 0.01 to 5.0 from the viewpoint of storage stability of the treatment agent. The upper limit of the ratio is more preferably 4.5, still more preferably 4.0, particularly preferably 3.5, most preferably 2.5. On the other hand, the lower limit of the ratio is more preferably 0.05, still more preferably 0.1, particularly preferably 0.2, most preferably 0.3. The ratio is, for example, more preferably 0.05 to 4.5, particularly preferably 0.1 to 4.0. The molar ratio of the Bronsted acid compound (C) to the amino groups of the amino-modified silicone (A) refers to the ratio of the total number of moles of the Bronsted acid compound (C) to the total number of moles of the amino groups of the amino-modified silicone (A) contained in the treatment agent.

A total weight of the compound (B) and the derivative of the compound (B) with respect to 100 parts by weight of the Bronsted acid compound (C) is preferably 0.01 to 50 parts by weight from the viewpoint of suppressing the decomposition over time of the compound (B) and the derivative of the compound (B). The upper limit of the weight is more preferably 30 parts by weight, still more preferably 20 parts by weight, particularly preferably 10 parts by weight. On the other hand, the lower limit of the weight is more preferably 0.05 parts by weight, still more preferably 0.1 parts by weight, particularly preferably 0.3 parts by weight. The weight is, for example, more preferably 0.05 to 30 parts by weight, particularly preferably 0.1 to 20 parts by weight.

A weight ratio of the Brønsted acid compound (C) to the non-volatile content of the treatment agent of the present invention is preferably 0.02 to 30 wt % from the viewpoint of suppressing the decomposition over time of the compound (B) and the derivative of the compound (B). The upper limit of the weight ratio is more preferably 26 wts, still more preferably 20 wt %, particularly preferably 15 wt %. On the other hand, the lower limit of the weight ratio is more preferably 0.05 wt %, still more preferably 0.1 wt %, particularly preferably 0.3 wt %. The weight ratio is, for example, more preferably 0.05 to 15 wt %, particularly preferably 0.1 to 15 wt %.

When the treatment agent of the present invention further contains the hydrophilic solvent (D), a weight ratio of the hydrophilic solvent (D) to the non-volatile content of the treatment agent of the present invention is preferably 0.05 to 10 wt % from the viewpoint of improving the compatibility between the amino-modified silicone (A) and at least one selected from the compound (B) and the derivative of the compound (B). The upper limit of the weight ratio is more preferably 7 wt %, still more preferably 5 wt %, particularly preferably 3 wt %. On the other hand, the lower limit of the weight ratio is more preferably 0.07 wt %, still more preferably 0.1 wt %, particularly preferably 0.15 wt %. The weight ratio is, for example, more preferably 0.05 to 7 wt %, still more preferably 0.07 to 5 wt %.

### [Nonionic Surfactant (E)]

The treatment agent of the present invention preferably further contains a nonionic surfactant (E) from the viewpoint of being able to enhance emulsifiability. Examples of the nonionic surfactant (E) include polyoxyalkylene linear alkyl ethers such as polyoxyalkylene linear alkyl ethers, polyoxyethylene hexyl ether, polyoxyethylene heptyl ether, polyoxyethylene octyl ether, polyoxyethylene decyl ether, polyoxyethylene lauryl ether, polyoxyethylene tridecyl ether, polyoxyethylene tetradecyl ether, and polyoxyethylene cetyl ether; polyoxyalkylene branched primary alkyl ethers such as polyoxyethylene 2-ethylhexyl ether, polyoxyethylene isocetyl ether, and polyoxyethylene isostearyl ether; polyoxyalkylene secondary alkyl ethers such as polyoxyethylene 1-hexylhexyl ether, polyoxyethylene 1-octylhexyl ether, polyoxyethylene 1-hexyloctyl ether, polyoxyethylene 1-pentylheptyl ether, polyoxyethylene 1-heptylpentyl ether, polyoxyethylene 1-hexylheptyl ether, polyoxyethylene 1-heptylhexyl ether, polyoxyethylene 1-pentylcaptyl ether, and polyoxyethylene 1-captylpentyl ether; polyoxyalkylene alkenyl ethers such as polyoxyethylene oleyl ethers; polyoxyalkylene alkylphenyl ethers such as polyoxyethylene octylphenyl ether, polyoxyethylene nonylphenyl ether, and polyoxyethylene dodecylphenyl ether; polyoxyalkylene alkylaryl phenyl ethers such as polyoxyethylene tristyrylphenyl ether, polyoxyethylene distyrylphenyl ether, polyoxyethylene styrylphenyl ether, polyoxyethylene tribenzylphenyl ether, polyoxyethylene dibenzylphenyl ether, and polyoxyethylene benzylphenyl ether; acetylene-based surfactants in which alkylene oxide is added to acetylene alcohol or acetylene diol; polyoxyalkylene fatty acid esters such as polyoxyethylene monolaurate, polyoxyethylene monoolate, polyoxyethylene monostearate, polyoxyethylene monomyristylate, polyoxyethylene dilaurate, polyoxyethylene diolate, polyoxyethylene dimyristylate, and polyoxyethylene distearate; sorbitan esters such as sorbitan monopalmitate and sorbitan monooleate; polyoxyalkylene sorbitan fatty acid esters such as polyoxyethylene sorbitan monostearate and polyoxyethylene sorbitan monooleate; glycerin fatty acid esters such as glycerin monostearate, glycerin monolaurate, and glycerin monopalmitate; polyoxyalkylene sorbitol fatty acid esters; sucrose fatty acid esters; polyoxyalkylene castor oil ethers such as polyoxyethylene castor oil ethers; polyoxyalkylene hydrogenated castor oil ethers such as polyoxyethylene hydrogenated castor oil ethers; oxyethylene-oxypropylene block or random copolymers; and terminal sucrose etherified products of oxyethylene-oxypropylene block or random copolymers.

Among them, from the viewpoint of emulsion stability, it is preferable to contain at least one selected from polyoxyalkylene linear primary alkyl ethers, polyoxyalkylene linear secondary alkyl ethers, polyoxyalkylene branched primary alkyl ethers, polyoxyalkylene branched secondary alkyl ethers, polyoxyalkylene alkylphenyl ethers, polyoxyalkylene alkylaryl phenyl ethers, and acetylene-based surfactants, and it is preferable to contain at least one selected from polyoxyalkylene linear primary alkyl ethers, polyoxyalkylene linear secondary alkyl ethers, polyoxyalkylene branched primary alkyl ethers, and polyoxyalkylene branched secondary alkyl ethers.

A weight-average molecular weight of the nonionic surfactant (E) is preferably 2,000 or less, more preferably 200 to 1,800, more preferably 300 to 1,500, still more preferably 500 to 1,000. The nonionic surfactant may be used singly or in combination of two or more kinds thereof.

When the treatment agent of the present invention contains the nonionic surfactant (E), a weight ratio of the nonionic surfactant (E) to the non-volatile content of the treatment agent is preferably 5 to 75 wt % from the viewpoint of emulsion stability. The upper limit of the weight ratio is more preferably 60 wt %, still more preferably 50 wt %, particularly preferably 40 wt %. On the other hand, the lower limit of the weight ratio is more preferably 10 wt %, still more preferably 15 wt %, particularly preferably 20 wt %. The weight ratio is, for example, more preferably 5 to 50 wt %, still more preferably 10 to 40 wt %.

### [Other Surfactants]

The treatment agent for acrylic fibers of the present invention may contain a surfactant other than the nonionic surfactant and the Bronsted acid compound (C) as long as the effects of the present invention are not impaired. The surfactant is used as an emulsifier, an antistatic agent, and the like. The other surfactant is not particularly limited, and a known surfactant can be appropriately selected from anionic surfactants, cationic surfactants, and amphoteric surfactants and used. The surfactant may be used singly or in combination of two or more thereof.

Examples of the anionic surfactant include fatty acids (salts) such as oleic acid, palmitic acid, sodium oleate, potassium palmitate, and triethanolamine oleate; hydroxy group-containing carboxylic acids (salts) such as hydroxyacetic acid, potassium hydroxyacetate, lactic acid, and potassium lactate; polyoxyalkylene alkyl ether acetic acids (salts) such as polyoxyethylene tridecyl ether acetic acid (sodium salt); salts of carboxy group-multisubstituted aromatic compounds such as potassium trimellitate and sodium pyromellitate; alkylbenzenesulfonic acids (salts) such as dodecylbenzenesulfonic acid (sodium salt); polyoxyalkylene alkyl ether sulfonic acids (salts) such as polyoxyethylene 2-ethylhexyl ether sulfonic acid (potassium salt); higher fatty acid amide sulfonic acids (salts) such as stearoyl methyl taurine (sodium), lauroyl methyl taurine (sodium), myristoyl methyl taurine N (sodium), and palmitoyl methyl taurine (sodium); N-acyl sarcosinic acids (salts) such as lauroyl sarcosinic acid (sodium); alkylphosphonic acids (salts) such as octylphosphonate (potassium salt); aromatic phosphonic acids (salts) such as phenylphosphonate (potassium salt); alkyl phosphonic acid alkyl phosphate esters (salts) such as 2-ethylhexylphosphonate mono-2-ethylhexyl ester (potassium salt); nitrogen-containing alkylphosphonic acids (salts) such as aminoethylphosphonic acid (diethanolamine salt); alkyl sulfate esters (salts) such as 2-ethylhexyl sulfate (sodium salt); polyoxyalkylene sulfate esters (salts) such as polyoxyethylene 2-ethylhexyl ether sulfate (sodium salt); alkyl phosphate esters (salts) such as lauryl phosphate (potassium salt), cetyl phosphate (potassium salt), and stearyl phosphate (diethanolamine salt); polyoxyalkylene alkyl (alkenyl) ether phosphate esters (salts) such as polyoxyethylene lauryl ether phosphate (potassium salt) and polyoxyethylene oleyl ether phosphate (triethanolamine salt); polyoxyalkylene alkylphenyl ether phosphate esters (salts) such as polyoxyethylene nonylphenyl ether phosphate (potassium salt) and polyoxyethylene dodecylphenyl ether phosphate (potassium salt); long chain sulfosuccinate salts such as sodium di-2-ethylhexyl sulfosuccinate and sodium dioctyl sulfosuccinate; and long chain N-acyl glutamate salts such as monosodium N-lauroyl glutamate and disodium N-stearoyl-L-glutamate.

Among them, from the viewpoint of emulsion stability, it is preferable to contain at least one selected from polyoxyalkylene alkyl ether acetic acids (salts), polyoxyalkylene alkyl ether sulfonic acids (salts), alkylbenzenesulfonic acids (salts), polyoxyalkylene alkyl ether sulfonic acids (salts), and alkyl phosphate esters (salt), and it is preferable to contain at least one selected from polyoxyalkylene alkyl ether acetic acids (salts), polyoxyalkylene alkyl ether sulfonic acids (salts), and alkyl phosphate esters (salts).

Examples of the cationic surfactant include alkyl quaternary ammonium salts such as lauryltrimethylammonium chloride, myristyltrimethylammonium chloride, palmityltrimethylammonium chloride, stearyltrimethylammonium chloride, oleyltrimethylammonium chloride, cetyltrimethylammonium chloride, behenyltrimethylammonium chloride, coconut oil alkyltrimethylammonium chlorides, beef tallow alkyltrimethylammonium chlorides, stearyltrimethylammonium bromide, coconut oil alkyltrimethylammonium bromides, cetyltrimethylammonium methosulfate, oleyldimethylethylammonium ethosulfate, dioctyldimethylammonium chloride, dilauryldimethylammonium chloride, distearyldimethylammonium chloride, and octadecyldiethylmethylammonium sulfate; (polyoxyalkylene) alkylamino ether salts such as (polyoxyethylene) laurylamino ether lactate, stearylamino ether lactate, di(polyoxyethylene) laurylmethylamino ether dimethylphosphate, di(polyoxyethylene) laurylethylammonium ethosulfate, di(polyoxyethylene) hydrogenated beef tallow alkylethylamine ethosulfates, di(polyoxyethylene) laurylmethylammonium dimethylphosphate, and di(polyoxyethylene) stearylamine lactate; acylamide alkyl quaternary ammonium salts such as N-(2-hydroxyethyl)-N, N-dimethyl-N-stearoylamidopropylammonium nitrate, lanolin fatty acid amide propylethyldimethylammonium ethosulfate, and lauroyl amide ethylmethyldiethylammonium methosulfate; alkyl ethenoxy quaternary ammonium salts such as dipalmityl polyethenoxyethyl ammonium chloride and distearyl polyethenoxymethylammonium chloride; alkylisoquinolinium salts such as laurylisoquinolinium chloride; benzalkonium salts such as lauryldimethylbenzylammonium chloride and stearyldimethylbenzylammonium chloride; benzethonium salts such as benzyldimethyl {2-[2-(p-1,1,3,3-tetramethylbutylphenoxy) ethoxy]ethyl}ammonium chloride; pyridinium salts such as cetylpyridinium chloride; imidazolinium salts such as oleylhydroxyethylimidazolinium ethosulfate and laurylhydroxyethylimidazolinium ethosulfate; acyl basic amino acid alkyl ester salts such as N-cocoylarginine ethyl ester pyrrolidone carboxylate salts and N-lauroyllysine ethyl ethyl ester chloride; primary amine salts such as laurylamine chloride, stearylamine bromide, hydrogenated beef tallow alkylamine chlorides, and rosin amine acetate; secondary amine salts such as cetylmethylamine sulfate, laurylmethylamine chloride, dilaurylamine acetate, stearylethylamine bromide, laurylpropylamine acetate, dioctylamine chloride, and octadecylethylamine hydroxide; tertiary amine salts such as dilaurylmethylamine sulfate, lauryldiethylamine chloride, laurylethylmethylamine bromide, diethanolstearylamidoethylamine trihydroxyethylphosphate, and stearylamidoethylethanolamine urea polycondensate acetate; fatty acid amide guanidinium salts; and alkyltrialkylene glycol ammonium salts such as lauryl triethylene glycol ammonium hydroxide.

Examples of the amphoteric surfactant include imidazoline-based amphoteric surfactants such as 2-undecyl-N, N-(hydroxyethylcarboxymethyl)-2-imidazoline sodium salt and 2-cocoyl-2-imidazolinium hydroxide-1-carboxyethyloxy disodium salt; betaine-based amphoteric surfactants such as 2-heptadecyl-N-carboxymethyl-N-hydroxyethylimidazolium betaine, lauryldimethylaminoacetic betaine, alkyl betaines, amide betaines, and sulfobetaine; and amino acid amphoteric surfactants such as N-laurylglycine, N-lauryl-β-alanine, and N-stearyl-β-alanine.

### [Other Components]

The treatment agent for acrylic fibers of the present invention may contain components other than the above components as long as the effects of the present invention are not impaired. Examples of the other components include antioxidants such as phenol-based, amine-based, sulfur-based, phosphorus-based, and quinone-based antioxidants, antistatic agents such as quaternary ammonium salt-type cationic surfactants and amine salt-type cationic surfactants, lubricants such as alkyl esters of higher alcohols, higher alcohol ethers, and waxes, antibacterial agents, antiseptics, rust inhibitors, and moisture absorbers.

In addition, the treatment agent of the present invention may contain modified silicone other than the above-described amino-modified silicone as long as the effects of the present invention are not impaired. Examples of the modified silicone include amide-modified silicone, amide-polyether-modified silicone, epoxy-modified silicone, polyether-modified silicone, epoxy-polyether-modified silicone (see, for example, JP 4616934 B1, the content of which is incorporated herein by reference), carbinol-modified silicone, alkyl-modified silicone, phenol-modified silicone, methacrylate-modified silicone, alkoxy-modified silicone, and fluorine-modified silicone, and one type of modified silicone may be used, or a plurality of modified silicones may be used in combination.

The treatment agent of the present invention may contain one or more low-molecular-weight silicones. Examples of low-molecular-weight silicones include linear or cyclic silicones having 2 to 7 silicon atoms. Specific examples of the low-molecular-weight silicone include octamethylcyclotetrasiloxane, decamethylcyclopentasiloxane, dodecamethylcyclohexasiloxane, heptamethyloctyltrisiloxane, hexamethyldisiloxane, decamethyltetrasiloxane, and dodecamethylpentasiloxane. These low-molecular-weight silicones may be substituted with a group represented by General Formula (5) above or the like. These low-molecular-weight silicones may be contained as minor components of the amino-modified silicone (A).

A content of the low-molecular silicones in the treatment agent of the present invention is preferably 15 parts by weight or less with respect to 100 parts by weight of the amino-modified silicone (A).

The treatment agent for acrylic fibers of the present invention is preferably in a state in which the amino-modified silicone (A), at least one selected from the compound (B) and derivatives of the compound (B), and as necessary, the Bronsted acid compound (C), the hydrophilic solvent (D), and the nonionic surfactant (E) are dissolved, solubilized, emulsified, or dispersed in water.

A weight ratio of water and a weight ratio of non-volatile components in the entire treatment agent for acrylic fibers are not particularly limited. For example, the weight ratios may be appropriately determined in consideration of the transportation cost at the time of transporting the treatment agent for acrylic fibers of the present invention, the handling property depending on the emulsion viscosity, and the like. The weight ratio of water to the entire treatment agent for acrylic fibers is preferably 0.1 to 99.9 wt %, more preferably 10 to 99.5 wt %, particularly preferably 50 to 99 wt %. The weight ratio (concentration) of the non-volatile components to the entire treatment agent for acrylic fibers is preferably 0.01 to 99.9 wt %, more preferably 0.5 to 90 wts, particularly preferably 1 to 50 wt %.

The treatment agent for acrylic fibers of the present invention can be produced by mixing the components described above. The method for emulsifying and dispersing the components described above is not particularly limited, and a known method can be adopted. Examples of such a method include a method in which each component constituting the treatment agent for acrylic fibers is charged into warm water under stirring and emulsified and dispersed, and a method in which each component constituting the treatment agent for acrylic fibers is mixed, and water is gradually charged while a mechanical shear force is applied using a homogenizer, a homo-mixer, a ball mill, or the like to perform phase inversion emulsification. In addition, a method of dissolving and dispersing the remaining components after emulsifying some components may be used.

The treatment agent for acrylic fibers of the present invention can be suitably used as a treatment agent (precursor treatment agent) for acrylic fibers (precursor) for carbon fiber production. It may also be used as a spinning oil for acrylic fibers other than the precursor.

### [Acrylic Fibers for Carbon Fiber Production, Method for Production Thereof, and Method for Producing Carbon Fibers]

The acrylic fibers (precursor) for carbon fiber production of the present invention are obtained by attaching the treatment agent for acrylic fibers to raw material acrylic fibers of a precursor and making a yarn. The method for producing a precursor of the present invention includes a yarn-making step of attaching the above treatment agent for acrylic fibers to raw material acrylic fibers of the precursor and making a yarn.

The method for producing carbon fibers of the present invention includes a flame resistance enhancing treatment step of converting the precursor provided with the treatment agent for acrylic fibers into flame resistant fibers in an oxidizing atmosphere at 200 to 300° C., and a carbonization treatment step of further carbonizing the flame resistant fibers in an inert atmosphere at 300 to 2,000° C.

Since the method for producing carbon fibers of the present invention employs the treatment agent for acrylic fibers of the present invention, disturbance of fiber bundles and stretching unevenness are reduced by improving the bundling property, and high-quality carbon fibers can be obtained.

The yarn-making step is a step of attaching the treatment agent for acrylic fibers to the raw material acrylic fibers of the precursor and spinning the precursor and preferably includes an attachment treatment step and a stretching step.

The attachment treatment step is a step of spinning the raw material acrylic fibers of the precursor and then attaching the treatment agent for acrylic fibers. That is, the treatment agent for acrylic fibers is attached to the raw material acrylic fibers of the precursor in the attachment treatment step. When the raw material acrylic fibers of the precursor are stretched immediately after spinning, high ratio stretching after the attachment treatment step is particularly referred to as the “stretching step”. The stretching step may be a wet heat stretching method using high temperature water vapor (steam) or a dry heat stretching method using a heat roller. Regarding the stretch ratio in the stretching step, the total stretch ratio is preferably 2 to 20 times with respect to the raw material acrylic fibers immediately after spinning.

The precursor is preferably composed of acrylic fibers containing, as a main component, polyacrylonitrile obtained by copolymerizing at least 95 mol % or more of acrylonitrile and 5 mol % or less of a flame resistance promoting component. As the flame resistance promoting component, a vinyl group-containing compound copolymerizable with acrylonitrile can be suitably used. The single fiber fineness of the precursor is not particularly limited, but is preferably 0.1 to 2.0 dtex from the viewpoint of the balance between the performance and the production cost. The number of monofilaments constituting the fiber bundle of the precursor is also not particularly limited, but is preferably 1,000 to 96,000 from the viewpoint of the balance between the performance and the production cost.

The treatment agent for acrylic fibers may be attached to the raw material acrylic fibers of the precursor at any stage of the carbon fiber production process, but it is preferable to attach the treatment agent once before the stretching step. The attachment may be performed in any step before the stretching step, such as immediately after spinning. Further, attachment may be performed in any step after the stretching step, such as immediately after the stretching step, in the winding stage, or immediately before the flame resistance enhancing treatment step. The attachment may be performed using a roller or the like, or may be performed by an immersion method, a spray method, or the like.

In the attachment treatment step, the application rate of the treatment agent for acrylic fibers is preferably 0.1 to 5 wt %, more preferably 0.3 to 1.5 wt % with respect to the weight of the precursor, from the viewpoint of the balance between obtaining the effect of preventing sticking between fibers and preventing fusion and preventing deterioration in the quality of carbon fibers caused by the treatment agent turned into tar in the carbonization treatment step. The application rate of the treatment agent for acrylic fibers as used herein is defined as the percentage of the non-volatile content weight of the attached treatment agent for acrylic fibers to the precursor weight.

The flame resistance enhancing treatment step is a step of converting the precursor to which the treatment agent for acrylic fibers is attached into flame resistant fibers in an oxidizing atmosphere at 200 to 300° C. The oxidizing atmosphere may be usually an air atmosphere. The temperature of the oxidizing atmosphere is preferably 230 to 280° C. In the flame resistance enhancing treatment step, the acrylic fibers after the attachment treatment are subjected to heat treatment for 20 to 100 minutes (preferably 30 to 60 minutes) while a tension of a stretch ratio of 0.90 to 1.10 (preferably 0.95 to 1.05) is applied. In this treatment for enhancing flame resistance, flame resistant fibers having a flame resistant structure is produced through intramolecular cyclization and oxygen addition to the ring.

The carbonization treatment step is a step of further carbonizing the flame resistant fibers in an inert atmosphere at 300 to 2,000° C. In the carbonization treatment step, first, it is preferable to perform a preliminary carbonization treatment step (first carbonization treatment step) by subjecting the flame resistant fibers to heat treatment for several minutes in a calcination furnace having a temperature gradient from 300° C. to 800° C. in an inert atmosphere of nitrogen, argon, or the like while applying a tension of a stretch ratio of 0.95 to 1.15 to the flame resistant fibers. Thereafter, in order to further progress carbonization and graphitization, heat treatment is performed for several minutes in an inert atmosphere of nitrogen, argon, or the like while a tension of a stretch ratio of 0.95 to 1.05 with respect to the first carbonization treatment step is applied to perform a second carbonization treatment step to carbonize the flame resistant fibers. For the control of the heat treatment temperature in the second carbonization treatment step, the maximum temperature is preferably 1,000° C. or higher (preferably 1,000 to 2,000° C.) while applying a temperature gradient. The maximum temperature is appropriately selected and determined according to desired required characteristics (tensile strength, elastic modulus, and the like) of the carbon fibers.

In the method for producing carbon fibers of the present invention, when carbon fibers having a higher elastic modulus is desired, a graphitization treatment step can be performed subsequently to the carbonization treatment step. The graphitization treatment step is usually performed in an inert atmosphere of nitrogen, argon, or the like at a temperature of 2,000 to 3,000° C. while applying tension to the fibers obtained in the carbonization treatment step.

The carbon fibers thus obtained can be subjected to surface treatment for enhancing the adhesive strength to the matrix resin when formed into a composite material according to the purpose. As the surface treatment method, gas phase treatment or liquid phase treatment can be adopted, and from the viewpoint of productivity, liquid phase treatment with an electrolytic solution such as an acid or an alkali is preferable. Furthermore, in order to improve the processability and handleability of the carbon fibers, various sizing agents having excellent compatibility with the matrix resin can also be applied.

### EXAMPLES

Hereinafter, the present invention will be specifically described with reference to examples, but the present invention is not limited to the examples described herein. The percentages (%) and parts shown in the following examples indicate “wt %” and “parts by weight” unless otherwise specified. The measurement of each characteristic value was performed on the basis of the following methods.

### <Application Rate of Treatment Agent>

The precursor after application of the treatment agent was subjected to alkali fusion with potassium hydroxide/sodium butyrate, then dissolved in water, and adjusted to a pH of 1 with hydrochloric acid. The color of the mixture was developed by adding sodium sulfite and ammonium molybdate, and the content of silicon was determined by performing colorimetric determination (wavelength: 815 nm) of silicomolybdenum blue. Using the silicon content determined here and the value of the silicon content in the treatment agent determined in advance by the same method, the application rate (wt %) of the treatment agent for acrylic fibers was calculated.

### <Operability at the Time of Calcination (Bundling Property)>

In the precursor calcination step, the passing state of the flame resistant fiber bundles immediately after passing through the calcination furnace was determined according to the following evaluation criteria.

A: The fiber bundle width does not increase, there is no interference with the adjacent fiber bundle, and the operability is particularly good.

B: The fiber bundle width slightly increases, there is no interference with the adjacent fiber bundle, and the operability is good.

C: The fiber bundle width increases, the fiber bundle interferes with the adjacent fiber bundle, fuzz is sometimes caused, and operability is poor.

### <Abrasion Resistance>

A precursor strand (12 K) was rubbed 1,000 times (reciprocating speed: 300 times/min) with a tension of 50 g through 3 mirror-finished chromium plated stainless steel needles arranged in a zigzag manner using a TM type abrasion cohesive force tester TM-200 (manufactured by Daiei Kagaku Seiki Mfg. Co., Ltd.), and the state of fuzz of the precursor strand was visually determined according to the following criteria.

A: As before abrasion, no fuzz is observed, and abrasion resistance is very good.

B: Several pieces of fuzz are observed, but the abrasion resistance is good.

C: A somewhat large number of pieces of fuzz are observed, and the abrasion resistance is slightly poor.

D: A large number of pieces of fuzz are observed, significant single yarn breakage is observed, and the abrasion resistance is poor.

### <Carbon Fiber Strength>

The carbon fiber strength was measured in accordance with the epoxy resin-impregnated strand method specified in JIS-R-7601, and the average value of 10 measurements was taken as the carbon fiber strength (GPa).

### Example 1

Amino-modified silicone A1, nonionic surfactants E1 and E2, antioxidants F1 and F2, and water were mixed and water-based emulsified so as to have the non-volatile composition of the treatment agent shown in Table 1, and then compounds B2 and B3 having 5-membered ring structures containing sulfur atoms and nitrogen atoms, a Bronsted acid compound C2, a hydrophilic solvent D4, and an antistatic agent were dissolved and dispersed to prepare a treatment agent for acrylic fibers having a non-volatile concentration of 30 wt %. In the non-volatile content of the treatment agent, the weight ratio of the amino-modified silicone A1 was 85 wt %, the total weight ratio of the compounds B2 and B3 having 5-membered ring structures containing sulfur atoms and nitrogen atoms was 0.02 wt %, the weight ratio of the Bronsted acid compound C2 was 2.5 wt %, the weight ratio of the hydrophilic solvent D4 was 0.18 wt %, the weight ratio of the nonionic surfactant E1 was 3 wt %, the weight ratio of the nonionic surfactant E2 was 5.3 wt %, the weight ratio of the antistatic agent was 3 wt %, and the total weight ratio of the antioxidants F1 and F2 was 1 wt %.

Next, the prepared treatment agent was further diluted with water to provide a diluted solution having a non-volatile content concentration of 3.0 wt %.

The diluted solution was attached to raw material acrylic fibers of a precursor, which was obtained by copolymerizing 97 mol % of acrylonitrile and 3 mol % of itaconic acid, in such a manner that the application rate of the non-volatile content of the treatment agent was 1.0 wt %, and a precursor (single fiber fineness: 0.8 dtex, 24,000 filaments) was produced through a stretching step (steam stretching, stretch ratio: 2.1 times). This precursor was subjected to treatment for enhancing flame resistance in a calcination furnace at 250° C. for 60 minutes, and then calcined in a carbonization furnace having a temperature gradient of 300 to 1,400° C. under a nitrogen atmosphere to be converted into carbon fibers.

The evaluation results of each characteristic value are shown in Table 1.

### Examples 2 to 83, Comparative Examples 1 to 40

Precursors and carbon fibers after attachment of the treatment agents were obtained in the same manner as in Example 1 except that treatment liquids were prepared such that the non-volatile compositions of the treatment agents were as shown in Tables 1 to 12. The evaluation results of each characteristic value are shown in Tables 1 to 12.

The details of the compositions of the non-volatile components in Tables 1 to 12 are as follows.

### <Amino-Modified Silicone (A)>

Amino-modified silicone A1:25° C. kinematic viscosity: 90 mm²/s, amino equivalent: 3,900 g/mol, diamine type (trade name: DOWSIL (registered trademark) BY 16-205, manufactured by Dow Toray Co., Ltd.)

Amino-modified silicone A2:25° C. kinematic viscosity: 60 mm²/s, amino equivalent: 2, 700 g/mol (trade name: DOWSIL (registered trademark) BY 16-213, manufactured by Dow Toray Co., Ltd.)

Amino-modified silicone A3:25° C. kinematic viscosity: 1,200 mm²/s, amino equivalent: 600 g/mol, diamine type (trade name: DOWSIL (registered trademark) BY 16-849 Fluid, manufactured by Dow Toray Co., Ltd.)

Amino-modified silicone A4:25° C. kinematic viscosity: 1,500 mm²/s, amino equivalent: 7,500 g/mol, diamine type (trade name: DOWSIL (registered trademark) BY 16-879B, manufactured by Dow Toray Co., Ltd.)

Amino-modified silicone A5:25° C. kinematic viscosity: 220 mm²/s, amino equivalent: 1,700 g/mol, diamine type (trade name: DOWSIL (registered trademark) FZ-3760, manufactured by Dow Toray Co., Ltd.)

Amino-modified silicone A6:25° C. kinematic viscosity: 3,500 mm²/s, amino equivalent: 6,000 g/mol, diamine type (trade name: DOWSIL (registered trademark) FZ-3785, manufactured by Dow Toray Co., Ltd.)

Amino-modified silicone A7:25° C. kinematic viscosity: 250 mm²/s, amino equivalent: 7, 600 g/mol, diamine type (trade name: KF-860, manufactured by Shin-Etsu Chemical Co., Ltd.)

Amino-modified silicone A8:25° C. kinematic viscosity: 3,500 mm²/s, amino equivalent: 2,000 g/mol, diamine type (trade name: KF-861, manufactured by Shin-Etsu Chemical Co., Ltd.)

Amino-modified silicone A9:25° C. kinematic viscosity: 1,700 mm²/s, amino equivalent: 3,800 g/mol, monoamine type (trade name: KF-864, manufactured by Shin-Etsu Chemical Co., Ltd.)

Amino-modified silicone A10:25° C. kinematic viscosity: 1,300 mm²/s, amino equivalent: 1,700 g/mol, diamine type (trade name: KF-867S, manufactured by Shin-Etsu Chemical Co., Ltd.)

Amino-modified silicone A11:25° C. kinematic viscosity: 1,500 mm²/s, amino equivalent: 3,800 g/mol, diamine type (trade name: KF-869, manufactured by Shin-Etsu Chemical Co., Ltd.)

Amino-modified silicone A12:25° C. kinematic viscosity: 7,000 mm²/s, amino equivalent: 4,000 g/mol (trade name: WACKER (registered trademark) FINISH WT 1200, manufactured by Wacker Asahikasei Silicone Co., Ltd.)

Amino-modified silicone A13:25° C. kinematic viscosity: 200 mm²/s, amino equivalent: 4,000 g/mol (trade name: WACKER (registered trademark) FINISH WT 1270, manufactured by Wacker Asahikasei Silicone Co., Ltd.)

Amino-modified silicone A14:25° C. kinematic viscosity: 75 mm²/s, amino equivalent: 8, 300 g/mol (trade name: WACKER (registered trademark) L653, manufactured by Wacker Asahikasei Silicone Co., Ltd.)

Amino-modified silicone A15:25° C. kinematic viscosity: 25 mm²/s, amino equivalent: 800 g/mol (trade name: WACKER (registered trademark) L656, manufactured by Wacker Asahikasei Silicone Co., Ltd.)

Amino-modified silicone A16:25° C. kinematic viscosity: 3,300 mm²/s, amino equivalent: 1,800 g/mol (trade name: X-22-3939A, manufactured by Shin-Etsu Chemical Co., Ltd.)

Amino-modified silicone A17:25° C. kinematic viscosity: 15,000 mm²/s, amino equivalent: 3, 600 g/mol, diamine type

Amino-modified silicone A18:25° C. kinematic viscosity: 9,000 mm²/s, amino equivalent: 9,000 g/mol, diamine type

### <Compound (B) and Derivative of Compound (B)>

Compound B1: a compound of Formula (1) in which R¹ is an octyl group, and X and Y are hydrogen atoms

Compound B2: a compound of Formula (1) in which R¹ is a methyl group, X is a chlorine atom, and Y is a hydrogen atom

Compound B3: a compound of Formula (1) in which R¹ is a methyl group, and X and Y are hydrogen atoms

Compound B4: a compound of Formula (2) in which R¹ is a hydrogen atom

Compound B5: a compound of Formula (2) in which R¹ is a butyl group

Compound B6:4-bromothiazole

Compound B7:2-amino-1,3,4-thiadiazole

Compound B8: a reaction product of B1 and cysteine (molar ratio 1:1)

Compound B9: the sodium salt of B4

<Components Other than Compound (B) and Derivative of Compound (B)>

Compound B′1: 1,4-thiazine

Compound B′2: 3-methylthiophene

Compound B′3: indole

### <Bronsted Acid Compound (C)>

Bronsted acid compound C1: acetic acid

Bronsted acid compound C2: phosphoric acid

Bronsted acid compound C3: benzoic acid

Bronsted acid compound C4: arginine

Bronsted acid compound C5: an alkyl ether acetate having 12 carbon atoms to which 4.5 mol of oxyethylene groups are added (trade name: Kao Akypo (registered trademark) RLM-45, manufactured by Kao Corporation)

Bronsted acid compound C6: an alkyl ether acetate having 12 carbon atoms to which 6 mol of oxyethylene groups are added (trade name: TIPOL SOFT ECA-490, manufactured by TAIKO OIL CHEM. Co., Ltd.)

Bronsted acid compound C7: an alkyl ether acetate having 12 carbon atoms to which 10 mol of oxyethylene groups are added (trade name: Kao Akypo (registered trademark) RLM-100, manufactured by Kao Corporation)

Bronsted acid compound C8: an alkyl ether phosphate ester having 18 carbon atoms to which 3 mol of oxyethylene groups are added (trade name: Phosphanol (registered trademark) RL-310, manufactured by TOHO Chemical Industry Co., Ltd.)

Bronsted acid compound C9: a secondary alkyl ether phosphate ester having 12 to 15 carbon atoms to which 3 mol of oxyethylene groups are added (trade name: Phosphanol (registered trademark) RS-410, manufactured by TOHO Chemical Industry Co., Ltd.)

Bronsted acid compound C10: a secondary alkyl ether phosphate ester having 12 to 15 carbon atoms to which 9 mol of oxyethylene groups are added (trade name: Phosphanol (registered trademark) RS-710, manufactured by TOHO Chemical Industry Co., Ltd.)

### <Hydrophilic Solvent (D)>

Hydrophilic solvent D1: monoethylene glycol
Hydrophilic solvent D2: diethylene glycol
Hydrophilic solvent D3: propylene glycol
Hydrophilic solvent D4: tripropylene glycol
Hydrophilic solvent D5: N, N-dimethylformamide
Hydrophilic solvent D6:1-methyl-2-pyrrolidone

### <Nonionic Surfactant (E)>

Nonionic surfactant E1: an alkyl ether having 12 carbon atoms to which 3 mol of oxyethylene groups are added (trade name: EMULGEN (registered trademark) 103, manufactured by Kao Corporation)

Nonionic surfactant E2: an alkyl ether having 12 carbon atoms to which 6 mol of oxyethylene groups are added (trade name: EMULGEN (registered trademark) 108, manufactured by Kao Corporation)

Nonionic surfactant E3: an alkyl ether having 18 carbon atoms to which 13 mol of oxyethylene groups are added (trade name: EMULGEN (registered trademark) 320P, manufactured by Kao Corporation)

Nonionic surfactant E4: polyoxyethylene tribenzylphenyl ether (trade name: EMULGEN (registered trademark) B-66, manufactured by Kao Corporation)

Nonionic surfactant E5: an acetylene-based surfactant (trade name: OLFINE (registered trademark) E1010, manufactured by Nissin Chemical Industry Co., Ltd.)

Nonionic surfactant E6: an acetylene-based surfactant (trade name: OLFINE (registered trademark) EXP-4123, manufactured by Nissin Chemical Industry Co., Ltd.)

Nonionic surfactant E7: an acetylene-based surfactant (trade name: OLFINE (registered trademark) PD-001, manufactured by Nissin Chemical Industry Co., Ltd.)

Nonionic surfactant E8: an acetylene-based surfactant (trade name: Surfynol (registered trademark) 104E, manufactured by Nissin Chemical Industry Co., Ltd.)

Nonionic surfactant E9: an acetylene-based surfactant (trade name: Surfynol (registered trademark) 440, manufactured by Nissin Chemical Industry Co., Ltd.)

Nonionic surfactant E10: an acetylene-based surfactant (trade name: Surfynol (registered trademark) 485, manufactured by Nissin Chemical Industry Co., Ltd.)

Nonionic surfactant E11: a secondary alkyl ether having 12 to 14 carbon atoms to which 5 mol of oxyethylene groups are added (trade name: SOFTANOL (registered trademark) 50, manufactured by Nippon Shokubai Co., Ltd.)

Nonionic surfactant E12: a secondary alkyl ether having 12 to 14 carbon atoms to which 9 mol of oxyethylene groups are added (trade name: SOFTANOL (registered trademark) 90, manufactured by Nippon Shokubai Co., Ltd.)

Nonionic surfactant E13: a secondary alkyl ether having 12 to 14 carbon atoms to which 12 mol of oxyethylene groups are added (trade name: SOFTANOL (registered trademark) 120, manufactured by Nippon Shokubai Co., Ltd.)

Nonionic surfactant E14: polyoxyethylene polyoxypropylene butyl ether (trade name: NEWPOL (registered trademark) 50-HB, manufactured by Sanyo Chemical Industries, Ltd.)

Nonionic surfactant E15: polyoxyethylene polyoxypropylene glycol (trade name: NEWPOL (registered trademark) MAP-4000, manufactured by Sanyo Chemical Industries, Ltd.)

Nonionic surfactant E16: polyoxyethylene polyoxypropylene glycol (trade name: NEWPOL (registered trademark) PE-64, manufactured by Sanyo Chemical Industries, Ltd.)

Nonionic surfactant E17: a polyoxyalkylene branched decyl ether (trade name: NOIGEN (registered trademark) XL-41, manufactured by DKS Co. Ltd.)

Nonionic surfactant E18: a polyoxyalkylene branched decyl ether (trade name: NOIGEN (registered trademark) XL-80, manufactured by DKS Co. Ltd.)

Nonionic surfactant E19: nonylphenyl ether to which 3 mol of oxyethylene groups are added (trade name: BLAUNON (registered trademark) BNP-30A, manufactured by Aoki Oil Industrial Co., Ltd.)

Nonionic surfactant E20: an alkyl ether having 16 carbon atoms to which 3 mol of oxyethylene groups are added (trade name: BLAUNON (registered trademark) CH-313, manufactured by Aoki Oil Industrial Co., Ltd.)

Nonionic surfactant E21: nonylphenyl ether to which 5 mol of oxyethylene groups are added (trade name: BLAUNON (registered trademark) N-505, manufactured by Aoki Oil Industrial Co., Ltd.)

### <Other Components>

Antioxidant F1: triethylene glycol-bis-3-(3-tert-butyl-4-hydroxy-5-methylphenyl) propionate

Antioxidant F2: dioleyl thiodipropionate

Antistatic agent:
ethylenebis(hydroxyethyl) octadecylammonium ethylsulfate

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Composition of | A1 | 85 | 80 | 75 | 70 | | | | | | |
| non-volatile | A2 | | | | | 85 | 80 | 70 | | | |
| components (wt %) | A3 | | | | | | | | 85 | 80 | 80 |
| | A7 | | | | | | | 20 | | | |
| | B1 | | | | | | 0.008 | | | | |
| | B2 | 0.01 | | 0.005 | | | | | 0.02 | 0.01 | |
| | B3 | 0.01 | | | | 0.015 | 0.002 | 0.02 | | | |
| | B4 | | 0.01 | | 0.03 | | | 0.02 | | | 0.002 |
| | B5 | | | 0.005 | 0.02 | 0.005 | | | | 0.01 | 0.008 |
| | B6 | | | | | | | | | | |
| | B7 | | 0.01 | | | | | | | | |
| | C1 | | | | 1.5 | | 0.5 | 0.2 | | 3 | |
| | C2 | 2.5 | | 2 | | | | | 2 | | |
| | C3 | | | | | | | | | | |
| | C4 | | | | | | | | | | 5 |
| | C5 | | | | | | | | | | |
| | C6 | | | | | | 1 | | | | |
| | C7 | | | | | 2 | | | | | |
| | C8 | | | 3.5 | | | | | | | |
| | C9 | | | | | | | | | | |
| | C10 | | 1.5 | | | | | | | | |
| | D1 | | | | | | 0.09 | | | | |
| | D2 | | 0.29 | | | 0.18 | | | 0.18 | 0.18 | |
| | D3 | | 0.39 | 0.1 | | | | 1.4 | 0.1 | | 0.09 |
| | D4 | 0.18 | | | | | | | | | |
| | D5 | | | 0.1 | | | | 0.56 | | | |
| | D6 | | | 0.09 | | | | | | | 0.1 |
| | E1 | 3 | | | | | | | | 3.5 | |
| | E2 | 5.3 | | | | | | 3.2 | 7.5 | | |
| | E3 | | | | | | | | 5.2 | 5.3 | |
| | E4 | | 5.3 | | | | | | | | |
| | E5 | | | | | 3.5 | | | | | |
| | E6 | | | | | | | 1.2 | | | |
| | E7 | | | | | | 4.8 | | | | |
| | E8 | | | 5.8 | | | | | | 5 | |
| | E9 | | | | | | | | | | |
| | E10 | | | | | | | | | | 4.5 |
| | E11 | | | 3.8 | | | | | | | |
| | E12 | | | | 10 | | | | | | |
| | E13 | | | 5.6 | | | | | | | |
| | E14 | | 6.5 | | | 5.8 | | | | | |
| | E15 | | 6 | | | 2.3 | | | | | |
| | E16 | | | | 7.45 | 1.2 | | | | | |
| | E17 | | | | 10 | | | | | | 4.2 |
| | E18 | | | | | | | | | | 6.1 |
| | E19 | | | | | | 5.7 | | | | |
| | E20 | | | | | | | 3.4 | | | |
| | E21 | | | | | | 7.9 | | | | |
| | AntioxidantF1 | 0.5 | | 0.5 | 0.3 | | | | | 0.5 | |
| | AntioxidantF2 | 0.5 | | 0.5 | 0.7 | | | | | 0.5 | |
| | Antistatic agent | 3 | | 3 | | | | | | 2 | |

| | | | | | | | | | | |
|---|---|---|---|---|---|---|---|---|---|---|
| Molar ratio of C to amino groups of A | 1.17 | 0.08 | 1.33 | 1.39 | 0.09 | 0.35 | 0.12 | 0.14 | 0.38 | 0.22 |
| Total weight (parts by weight) of B and | 0.80 | 1.33 | 0.18 | 3.33 | 1.00 | 0.67 | 20.00 | 1.00 | 0.67 | 0.20 |
| B derivatives with respect to 100 parts | | | | | | | | | | |
| by weight of C | | | | | | | | | | |
| Application rate (%) of treatment agent | 1.0 | 0.9 | 1.0 | 1.1 | 0.9 | 1.0 | 1.1 | 1.0 | 1.0 | 1.1 |
| Bundling property | A | A | A | A | A | A | A | A | A | A |
| Abrasion resistance | A | B | A | A | A | A | A | B | A | A |
| Carbon fiber strength (Gpa) | 4.94 | 4.85 | 4.92 | 4.89 | 4.88 | 4.92 | 4.97 | 4.98 | 4.97 | 4.96 |

TABLE 2

| | | Example | | | | | | | | | |
|---|---|---|---|---|---|---|---|---|---|---|---|
| | | 11 | 12 | 13 | 14 | 15 | 16 | 17 | 18 | 19 | 20 |
| Composition | A3 | 75 | 70 | 65 | | | | | | | |
| of non- | A4 | | | | 85 | 80 | 80 | 80 | 75 | 75 | 60 |
| volatile | A16 | | | | | | | | | | 25 |
| components | B1 | | 0.008 | 0.001 | 0.02 | 0.005 | | | 0.007 | | |
| (wt %) | B2 | | 0.012 | | 0.01 | | 0.02 | | | | |
| Molar ratio of | B3 | 0.013 | | 0.002 | | | | | | | |
| | B4 | | | 0.002 | | | 0.0 | 0.01 | 0.013 | | 0.05 |
| | B5 | | | | | | | 0.01 | | 0.02 | |
| | B6 | 0.017 | | | | | | | | 0.02 | |
| | B7 | | | | | 0.005 | | | | | |
| | C1 | | | | | | | | | | |
| | C2 | 2 | | | 2 | | 2 | | 5 | | |
| | C3 | | | | | | | | | | |
| | C4 | | | | 1 | | | | | | |
| | C8 | | | 10 | | | | | | | 10 |
| | C9 | | | | | 10 | | | | 5 | |
| | C10 | | | 5 | | | | | 10 | | |
| | D1 | | | 0.305 | | 0.09 | | | | | |
| | D2 | | | | 0.17 | | | | | | |
| | D3 | | 0.1 | | | 0.1 | 0.67 | | | 0.16 | |
| | D4 | | 0.1 | | | | 0.3 | 0.49 | | | |
| | D5 | 0.07 | | | | | | 0.29 | | | |
| | D6 | | 0.08 | 0.29 | | | | | | | 0.15 |
| | E1 | | | | | | | | 1.18 | | |
| | E2 | | | | | 2.4 | | | | 5.2 | |
| | E3 | | | 7.1 | | | | | 2.3 | 7.3 | |
| | E4 | | | | | | | | | | 2.8 |
| | E5 | | | | | 2 | | | | | |
| | E6 | | | | | | | | 2.5 | | |
| | E7 | | | | | | 7.3 | | | | |
| | E8 | | | | | | | | | | |
| | E9 | | | | 5.2 | | | | | | |
| | E10 | | | | | | | | | 4.3 | 2 |
| | E11 | 4.3 | | | | | | 4.3 | | | |
| | E12 | 7.5 | 15.8 | | | | | 8.6 | | | |
| | E13 | | | | | | | 3.3 | | | |
| | E14 | 8.1 | | | | | | | | | |
| | E15 | | 4.4 | | | | | | | | |
| | E16 | | 4.5 | 7.2 | | | | | | | |
| | E17 | | | | | | | | | | |
| | E18 | | | | | | | | | | |
| | E19 | | | 4.1 | 2.5 | | 4.2 | | | | |
| | E20 | | | | | 1.4 | | | | | |
| | E21 | | | | 4.1 | | 5.5 | | | | |
| | AntioxidantF1 | 0.7 | 0.2 | 0.2 | | 0.5 | | 0.7 | 0.5 | 0.7 | |
| | AntioxidantF2 | 0.3 | 0.8 | 0.8 | | 0.5 | | 0.3 | 0.5 | 0.3 | |
| | Antistatic agent | 2 | 4 | | | 3 | | 2 | 3 | 2 | |
| | C to amino groups of A | 0.16 | 0.00 | 0.18 | 2.31 | 1.62 | 1.91 | 0.00 | 6.13 | 0.86 | 0.68 |

| | | | | | | | | | | |
|---|---|---|---|---|---|---|---|---|---|---|
| Total weight (parts by weight) of B and | 1.50 | — | 0.03 | 1.00 | 0.10 | 1.50 | — | 0.13 | 0.80 | 0.50 |
| B derivatives with respect to 100 parts | | | | | | | | | | |
| by weight of C | | | | | | | | | | |
| Application rate (%) of treatment agent | 1.0 | 0.9 | 1.1 | 1.0 | 1.1 | 0.9 | 1.0 | 1.0 | 1.1 | 1.0 |
| Bundling property | A | A | A | A | A | A | A | A | A | A |
| Abrasion resistance | B | A | A | A | B | A | A | A | B | B |
| Carbon fiber strength (Gpa) | 4.94 | 4.83 | 4.81 | 4.96 | 4.95 | 4.96 | 4.82 | 4.82 | 4.95 | 4.95 |

TABLE 3

| | | Example | | | | | | | | | |
|---|---|---|---|---|---|---|---|---|---|---|---|
| | | 21 | 22 | 23 | 24 | 25 | 26 | 27 | 28 | 29 | 30 |
| Composition of non- | A5 | 80 | 80 | 75 | 70 | 50 | 35 | | | | |
| volatile components (wt %) | A6 | | | | | 30 | | 80 | 80 | 70 | |
| | A7 | | | | | | | | | | 85 |
| | A10 | | | | | | 50 | | | | |
| | B1 | 0.007 | | | | | | | | | 0.015 |
| | B2 | | 0.01 | | 0.005 | | | 0.02 | | | |
| | B3 | | 0.01 | | | | | | | 0.006 | 0.005 |
| | B4 | | | | | 0.01 | 0.02 | 0.01 | 0.015 | | |
| | B5 | 0.003 | | | 0.015 | 0.01 | | | 0.005 | 0.004 | |
| | B6 | | 0.01 | 0.008 | | | | | | | |
| | B7 | | | 0.012 | | | 0.01 | | | | |
| | C1 | 5 | 2.5 | | | 3 | | | | | |
| | C5 | | | | 2.5 | | | | | | |
| | C6 | | | | | | 3 | | | | |
| | C7 | | | 2 | | | | | | | 2 |
| | C8 | | | | | | | | | | |
| | C9 | | | | | | | 4.5 | | | |
| | C10 | | | | | | | | | 3 | |
| | D1 | | | | | 0.74 | | 0.07 | | | |
| | D2 | | | 0.12 | | | | | | | 0.04 |
| | D3 | | | 0.08 | | | 0.17 | | | | 0.04 |
| | D4 | | | | | | | | | 0.19 | |
| | D5 | 0.49 | | | | 0.54 | | | | | |
| | D6 | | 0.17 | 0.08 | 0.18 | | | | | | |
| | E1 | | | | 3.2 | 4.2 | | 2.7 | | | |
| | E2 | | | | 11.5 | 4 | 5.2 | | 12.5 | | |
| | E3 | | | | 7.6 | | | | 6.48 | | |
| | E4 | | | | | | | | | | |
| | E5 | | | | | | | | | | |
| | E6 | | | | | | | | | 8.9 | 6 |
| | E7 | | | | | | | | | 7.6 | |
| | E8 | | | | | | | | | | |
| | E9 | | | | | | | | | | |
| | E10 | | | | | | | | | | |
| | E11 | 2 | 5.5 | 2.5 | | | | | | | 2 |
| | E12 | | 8.8 | 7.3 | | | | | | | 0.9 |
| | E13 | 7.8 | | 3.9 | | | | | | | 1 |
| | E14 | | 3 | | | | | | | 10.3 | |
| | E15 | | | 6 | | | | | | | |
| | E16 | 4.7 | | | 5 | | | 7.4 | | | |
| | E17 | | | | | | | | | | |
| | E18 | | | | | | | | | | |
| | E19 | | | | | | | | | | |
| | E20 | | | | | 3.5 | 2.6 | 5.3 | | | |
| | E21 | | | | | | | | | | |
| | AntioxidantF1 | | | 0.7 | | 1 | 1 | | | | 0.2 |
| | AntioxidantF2 | | | 0.3 | | | | | 1 | | 0.8 |
| | Antistatic agent | | | 2 | | 3 | 3 | | | | 2 |

| | | | | | | | | | | |
|---|---|---|---|---|---|---|---|---|---|---|
| Molar ratio of C to amino groups of A | 1.77 | 0.89 | 0.06 | 0.14 | 1.45 | 0.12 | 0.58 | 0.00 | 0.27 | 0.25 |
| Total weight (parts by weight) of B and B | 0.20 | 1.20 | 1.00 | 0.80 | 0.67 | 1.00 | 0.67 | — | 0.33 | 1.00 |
| derivatives with respect to 100 parts by | | | | | | | | | | |
| weight of C | | | | | | | | | | |
| Application rate (%) of treatment agent | 1.0 | 1.0 | 1.1 | 1.1 | 0.9 | 1.0 | 0.9 | 1.0 | 1.0 | 1.1 |
| Bundling property | A | A | B | A | A | A | A | A | A | A |
| Abrasion resistance | A | A | B | A | A | B | A | A | A | A |
| Carbon fiber strength (Gpa) | 4.93 | 4.96 | 4.87 | 4.95 | 4.95 | 4.95 | 4.96 | 4.83 | 4.93 | 4.95 |

TABLE 4

| | | Example | | | | | | | | | |
|---|---|---|---|---|---|---|---|---|---|---|---|
| | | 31 | 32 | 33 | 34 | 35 | 36 | 37 | 38 | 39 | 40 |
| Composition of non- | A7 | 80 | 80 | 70 | 75 | | | | | | |
| volatile components | A8 | | | | | 80 | 80 | 75 | 70 | 60 | 50 |
| (wt %) | A9 | | | | | | | | | | |
| | A10 | | | | | | | | | | 30 |
| | B1 | 0.004 | | 0.008 | | 0.006 | | | 0.003 | | |
| | B2 | | | | | | | | | | 0.01 |
| | B3 | 0.001 | 0.03 | | | 0.002 | 0.012 | 0.004 | | | |
| | B4 | | 0.02 | 0.012 | 0.005 | | 0.008 | | | | |
| | B5 | | | | 0.015 | 0.002 | | 0.006 | | 0.05 | 0.01 |
| | B6 | | | | | | | | | | |
| | B7 | | | | | | | | 0.017 | | |
| | C1 | | | | | | 1.5 | 3 | | | |
| | C2 | | | 3 | 1 | | | | | | |
| | C3 | | | | | | | | | 0.15 | |
| | C4 | | | | | | | | | | |
| | C5 | | | | | | | | 5 | | 2 |
| | C6 | | | | | 2 | | | | | |
| | C7 | 4 | | | | 1 | | | | | 3 |
| | C8 | | | | | | | | 5 | | |
| | C9 | | 3 | | | | | | | | |
| | C10 | | | | | | | | | | |
| | D1 | | | | | 0.09 | | | | | 0.08 |
| | D2 | 0.3 | | | 0.6 | | 0.08 | | | | 0.1 |
| | D3 | 0.455 | 0.15 | | 0.55 | | | 0.89 | | | 0.1 |
| | D4 | 0.04 | | | | | | | | | |
| | D5 | | | | 0.23 | | | | | | |
| | D6 | | 0.1 | 0.18 | | | | | 0.08 | | |
| | E1 | | | 5 | 7.2 | 3.3 | | | 5.5 | 5.2 | |
| | E2 | | | 10 | | | | | 10.2 | | |
| | E3 | | | | 12.4 | | | | | | |
| | E4 | | | | | | | | | 10.3 | |
| | E5 | | 2 | | | | | | | | |
| | E6 | 2 | | | | | | | | | |
| | E7 | | | | | | | | | 5.5 | |
| | E8 | | | | | | | | | | |
| | E9 | | | | | 4 | | | | | |
| | E10 | | | 6.8 | | | | | | | |
| | E11 | 3.7 | | | | | | | | | 3.6 |
| | E12 | 2.5 | | | | | | | | 8.6 | |
| | E13 | 2 | | | | 3.5 | | | | | 7.2 |
| | E14 | | | | | | | | | | 2.9 |
| | E15 | | | | | | | | | 5.4 | |
| | E16 | | | | | | | | 3.2 | | |
| | E17 | | | | | | 3.8 | 13.5 | | | |
| | E18 | | | | | 6.1 | 9.6 | 4.6 | | | |
| | E19 | | 4.7 | | | | | | | | |
| | E20 | | | | | | | | | | |
| | E21 | | 6 | | | | | | | 4.8 | |
| | AntioxidantF1 | 0.7 | 0.7 | 0.2 | 0.5 | | 0.5 | 0.5 | | | 1 |
| | AntioxidantF2 | 0.3 | 0.3 | 0.8 | 0.5 | | 0.5 | 0.5 | 1 | | |
| | Antistatic agent | 4 | 3 | 4 | 2 | | 4 | 2 | | | |

| | | | | | | | | | | |
|---|---|---|---|---|---|---|---|---|---|---|
| Molar ratio of C to amino groups of A | 0.52 | 0.49 | 3.32 | 1.03 | 0.13 | 0.63 | 1.33 | 0.54 | 0.04 | 0.20 |
| Total weight (parts by weight) of B and B | 0.13 | 1.67 | 0.67 | 2.00 | 0.33 | 1.33 | 0.33 | 0.20 | 33.33 | 0.40 |
| derivatives with respect to 100 parts by | | | | | | | | | | |
| weight of C | | | | | | | | | | |
| Application rate (%) of treatment agent | 1.1 | 0.9 | 0.9 | 1.0 | 1.0 | 1.0 | 1.1 | 1.1 | 0.9 | 0.9 |
| Bundling property | A | A | A | A | A | A | A | A | A | A |
| Abrasion resistance | A | A | A | A | A | A | A | B | B | A |
| Carbon fiber strength (Gpa) | 4.93 | 4.99 | 4.95 | 4.95 | 4.96 | 4.97 | 4.95 | 4.96 | 4.82 | 4.97 |

TABLE 5

| | | Example | | | | | | | | | |
|---|---|---|---|---|---|---|---|---|---|---|---|
| | | 41 | 42 | 43 | 44 | 45 | 46 | 47 | 48 | 49 | 50 |
| Composition of non- | A9 | 80 | 80 | 70 | 65 | 65 | | | | | |
| volatile components | A10 | | | | | | 90 | 85 | 85 | 80 | 80 |
| (wt %) | B1 | 0.01 | | | | | | | | 0.005 | 0.02 |
| | B2 | 0.02 | | 0.004 | | 0.02 | 0.015 | 0.01 | 0.007 | | |
| | B3 | | 0.005 | 0.001 | 0.04 | 0.01 | 0.005 | | 0.003 | 0.005 | 0.03 |
| | B4 | | | | | | | | | | |
| | B5 | | 0.005 | | | | | | | | |
| | C1 | | 3 | | | | 1 | | 1 | 2 | |
| | C2 | 5 | | 2 | 1 | 1 | | | | | |
| | C5 | | | | | | | | | | 3 |
| | C8 | | | | 15 | | | | | | |
| | C9 | | | 2 | | 25 | | | | 2 | |
| | C10 | | | | | | | | | | |
| | D1 | | | | 0.16 | | | 0.19 | 0.05 | | |
| | D2 | | | 0.09 | | 0.3 | | | 0.09 | 0.156 | |
| | D3 | | 0.12 | 0.105 | | 0.57 | 0.08 | | 0.05 | 0.004 | |
| | D4 | | | | | | 0.1 | | | | 0.15 |
| | D5 | 0.17 | 0.17 | | | | | | | | |
| | D6 | | | | 0.1 | | | | | 0.03 | |
| | E1 | | | | | | | 3.5 | | | |
| | E2 | | 4.5 | | | | | | | | |
| | E3 | | 10.2 | | | | | 5.8 | | | |
| | E8 | | | | | | | | | | 4.9 |
| | E9 | | | | | | | | | | |
| | E10 | | | | | | | | | | |
| | E11 | | | 18.5 | | 7.1 | 4.4 | | 8.1 | 2.8 | |
| | E12 | | | | 3.9 | | 4.4 | | 5.7 | 11 | |
| | E13 | | | 7.3 | 7.8 | 1 | | | | 2 | |
| | E14 | | | | 4 | | | | | | |
| | E15 | | 2 | | | | | | | | |
| | E16 | | | | | | | | | | |
| | E17 | 3.8 | | | | | | | | | 2 |
| | E18 | 7 | | | | | | | | | 4.3 |
| | E19 | | | | | | | | | | |
| | E20 | | | | | | | | | | |
| | E21 | | | | | | | 3.5 | | | 4.6 |
| | Antioxidant F1 | 0.7 | | | 0.7 | | | 0.5 | | | 0.2 |
| | Antioxidant F2 | 0.3 | | | 0.3 | | | 0.5 | | | 0.8 |
| | Antistatic agent | 3 | | | 2 | | | 1 | | | |

| | | | | | | | | | | |
|---|---|---|---|---|---|---|---|---|---|---|
| Molar ratio of C to amino groups of A | 2.42 | 2.38 | 1.30 | 1.90 | 3.12 | 0.31 | 0.00 | 0.33 | 0.78 | 0.14 |
| Total weight (parts by weight) of B and B | 0.60 | 0.33 | 0.13 | 0.25 | 0.12 | 2.00 | — | 1.00 | 0.25 | 1.67 |
| derivatives with respect to 100 parts by | | | | | | | | | | |
| weight of C | | | | | | | | | | |
| Application rate (%) of treatment agent | 1.0 | 1.1 | 1.0 | 1.1 | 0.9 | 1.1 | 1.0 | 1.1 | 0.9 | 1.0 |
| Bundling property | A | A | A | A | A | A | A | A | A | A |
| Abrasion resistance | A | A | A | B | A | A | B | A | A | A |
| Carbon fiber strength (Gpa) | 4.97 | 4.94 | 4.95 | 4.96 | 4.97 | 4.96 | 4.81 | 4.96 | 4.97 | 4.96 |

TABLE 6

| | | Example | | | | | | | | | |
|---|---|---|---|---|---|---|---|---|---|---|---|
| | | 51 | 52 | 53 | 54 | 55 | 56 | 57 | 58 | 59 | 60 |
| Composition of non- | A10 | 80 | 75 | 55 | | | | | | | |
| volatile components | A11 | | | | 90 | 85 | 12 | | | | |
| (wt %) | A12 | | | | | | | 80 | 75 | 65 | |
| | A13 | | | | | | | | | 20 | 85 |
| | A15 | | | 20 | | | | | | | |
| | A17 | | | | | | 18 | | | | |
| | B1 | | 0.018 | | | | 0.013 | | | | 0.01 |
| | B2 | 0.018 | | 0.01 | | 0.014 | | | | | |
| | B3 | 0.002 | 0.002 | | 0.01 | | 0.007 | | 0.017 | | |
| | B4 | | | | 0.02 | | | | | 0.003 | |
| | B5 | | | 0.03 | | 0.016 | | | 0.003 | 0.015 | 0.01 |
| | B6 | | | | | | | | | 0.002 | |
| | B7 | | | | | | | 0.04 | | | |
| | C1 | 3 | 1 | 1 | | | 0.3 | 0.5 | | | 2 |
| | C2 | | | | | | | | | | |
| | C3 | | | 1 | | | | | | | |
| | C4 | | | | | 3 | | | | | |
| | C5 | | | | | | | | 10 | | |
| | C6 | | | | 5 | | | | | 1.5 | |
| | C9 | | 7 | | | | | | | | |
| | D1 | 0.13 | | | 0.15 | | | | | | |
| | D2 | 0.5 | 0.05 | | | | 0.3 | | | 0.56 | 0.1 |
| | D3 | 0.45 | 0.13 | | | | 0.08 | | 0.28 | | 0.08 |
| | D4 | | | | | | | | | 0.42 | |
| | D5 | | | | | 0.07 | | | | | |
| | D6 | | 0.1 | | 0.12 | | | | | | |
| | E1 | | | 2.5 | | | | | | | |
| | E2 | | | 5.2 | | | | | 3.4 | | |
| | E3 | | | 7.3 | | | | | | 4.2 | |
| | E4 | | | | 4.7 | | 57.2 | | | | |
| | E5 | | | | | | | | | | |
| | E6 | | | 3.96 | | | 2.8 | | | | |
| | E7 | | | | | | | | | | |
| | E8 | | | | | 4.5 | | | | | |
| | E9 | | | | | | | | | | |
| | E10 | | | | | 3.4 | | | | | |
| | E11 | 7.2 | 9.8 | | | | 2.4 | | | 2.1 | 3.5 |
| | E12 | 8.7 | 6.7 | | | | 5.3 | | | | |
| | E13 | | 0.2 | | | | 1.6 | | 4.1 | | 6.3 |
| | E14 | | | | | | | | | | |
| | E15 | | | | | | | 5.8 | | | |
| | E16 | | | | | 4 | | 7.4 | | | |
| | E17 | | | | | | | 2.26 | | | |
| | E18 | | | | | | | | | | |
| | E19 | | | | | | | | 3.2 | | |
| | E20 | | | | | | | | | | |
| | E21 | | | | | | | | | 2.2 | |
| | AntioxidantF1 | | | 0.2 | | | | 0.5 | | 1 | 0.5 |
| | AntioxidantF2 | | | 0.8 | | | | 0.5 | 1 | | 0.5 |
| | Antistatic agent | | | 3 | | | | 3 | 3 | 3 | 2 |

| | | | | | | | | | | |
|---|---|---|---|---|---|---|---|---|---|---|
| Molar ratio of C to amino groups of A | 1.06 | 0.65 | 0.43 | 0.42 | 0.77 | 0.61 | 0.42 | 1.21 | 0.14 | 1.57 |
| Total weight (parts by weight) of B and B | 0.67 | 0.25 | 2.00 | 0.60 | 1.00 | 6.67 | 8.00 | 0.20 | 1.33 | 1.00 |
| derivatives with respect to 100 parts by | | | | | | | | | | |
| weight of C | | | | | | | | | | |
| Application rate (%) of treatment agent | 1.1 | 1.0 | 0.9 | 1.0 | 0.9 | 1.0 | 0.9 | 1.1 | 1.1 | 1.0 |
| Bundling property | A | A | A | A | A | A | B | A | A | A |
| Abrasion resistance | A | A | A | A | A | A | B | A | A | A |
| Carbon fiber strength (Gpa) | 4.98 | 5.00 | 4.89 | 4.97 | 4.97 | 4.95 | 4.88 | 4.97 | 4.97 | 4.95 |

TABLE 7

| | | Example | | | | | | | | | |
|---|---|---|---|---|---|---|---|---|---|---|---|
| | | 61 | 62 | 63 | 64 | 65 | 66 | 67 | 68 | 69 | 70 |
| Composition of non- | A13 | 85 | 80 | 80 | 80 | 75 | | | | | |
| volatile components | A14 | | | | | | 80 | 75 | | | |
| (wt %) | A15 | | | | | | | | 85 | 80 | |
| Molar ratio of C to | A16 | | | | | | | | | | 80 |
| | B1 | | | | | | 0.02 | | 0.01 | | |
| | B2 | | | | | | | 0.014 | | | |
| | B3 | | 0.02 | 0.01 | | 0.02 | 0.01 | | | 0.002 | |
| | B4 | 0.02 | 0.01 | | | | | 0.003 | | 0.008 | 0.015 |
| | B5 | | | 0.01 | 0.005 | | 0.01 | 0.003 | 0.01 | | |
| | B6 | | | | 0.01 | 0.01 | | | | | |
| | B7 | | | | 0.005 | | | | | | 0.005 |
| | C1 | | | | | | | | | | |
| | C2 | | | | 1 | | 0.1 | 1 | 5 | | 3 |
| | C4 | | | | | 3.5 | | | | | |
| | C5 | 3 | | | | | | | | | |
| | C6 | | | 2 | | | | | | | |
| | C7 | | | | | | | | | | |
| | C8 | | | 2 | | | | 4 | | | |
| | C10 | | | | | | | | | 15 | |
| | D1 | | | 0.18 | | 0.07 | | | | | |
| | D2 | 0.88 | | | | | 0.1 | 0.18 | | | 0.08 |
| | D3 | | | | | | 0.06 | | 0.09 | | |
| | D4 | | | | | 0.1 | | | | 0.09 | |
| | D5 | | | | | | | | 0.09 | | |
| | D6 | | | | 0.18 | | | | | | |
| | E1 | | | | | 5.6 | | | 4.1 | | |
| | E2 | | | | | 10.6 | | | | | |
| | E3 | | | | | | | | | | |
| | E4 | | 8.77 | | | 5.1 | | | | | |
| | E7 | 3.4 | | | | | | 5.5 | | | |
| | E8 | | | | 5.8 | | | | | | |
| | E9 | | | | | | | | | | |
| | E10 | | | | | | | | | | |
| | E11 | | | | | | 7.3 | | 2.5 | | |
| | E12 | | 3.7 | | | | 9.2 | | | | |
| | E13 | | 4.5 | | | | 3.2 | | | | 5.4 |
| | E14 | 3.5 | | 2.5 | | | | | | | |
| | E15 | | | 3.8 | | | | | | | 6.1 |
| | E16 | 4.2 | | 4.5 | | | | | | | |
| | E17 | | | | | | | 8.2 | | | |
| | E18 | | | | 5.7 | | | 5.1 | | | 5.4 |
| | E19 | | | | | | | | | 1.8 | |
| | E20 | | | | 4.3 | | | | | 3.1 | |
| | E21 | | | | | | | | 3.2 | | |
| | AntioxidantF1 | | 0.5 | 0.3 | 0.6 | | | 0.5 | | | |
| | AntioxidantF2 | | 0.5 | 0.7 | 0.4 | | | 0.5 | | | |
| | Antistatic agent | | 2 | 4 | 2 | | | | | | |
| | amino groups of A | 0.32 | 0.00 | 0.35 | 0.51 | 1.07 | 0.11 | 1.79 | 0.48 | 0.15 | 0.69 |

| | | | | | | | | | | |
|---|---|---|---|---|---|---|---|---|---|---|
| Total weight (parts by weight) of B and B | 0.67 | — | 0.50 | 2.00 | 0.86 | 40.00 | 0.40 | 0.40 | 0.07 | 0.67 |
| derivatives with respect to 100 parts by | | | | | | | | | | |
| weight of C | | | | | | | | | | |
| Application rate (%) of treatment agent | 1.1 | 1.1 | 0.9 | 0.9 | 1.0 | 1.0 | 0.9 | 1.0 | 1.0 | 0.9 |
| Bundling property | A | A | A | A | A | A | A | A | A | A |
| Abrasion resistance | B | A | A | B | B | A | A | A | A | B |
| Carbon fiber strength (Gpa) | 4.94 | 4.83 | 4.95 | 4.94 | 4.94 | 4.81 | 4.94 | 4.95 | 4.86 | 4.97 |

TABLE 8

| | | Example | | | | | | | |
|---|---|---|---|---|---|---|---|---|---|
| | | 71 | 72 | 73 | 74 | 75 | 76 | 77 | 78 |
| Composition of | A7 | | | | | | | | |
| non-volatile | A10 | | | | | | | | |
| components | A16 | 75 | 75 | 70 | 65 | | | | |
| (wt %) | A17 | | | | | 80 | 50 | 25 | |
| | A18 | | | | | | | | 80 |
| | B1 | | | 0.05 | | | 0.007 | | |
| | B2 | 0.023 | | | | 0.003 | | 0.01 | |
| | B3 | 0.007 | 0.02 | | | 0.007 | | | |
| | B4 | | | | | 0.01 | 0.013 | | 0.008 |
| | B5 | | | | 0.013 | | | 0.01 | 0.004 |
| | B6 | | 0.01 | | 0.004 | | | | |
| | B7 | | | | 0.003 | | | | 0.008 |
| | B8 | | | | | | | | |
| | B9 | | | | | | | | |
| | C1 | | | 2 | | 3 | | 0.3 | |
| | C2 | | | | | | | | 4 |
| | C5 | | | | 2.5 | | | | |
| | C6 | | | | | | | | |
| | C7 | | | | | | 5 | | |
| | C8 | | | | | | | | |
| | C9 | | 15 | | | | | | |
| | C10 | | | | | | | | |
| | D1 | | | | | | 0.8 | | |
| | D2 | | 0.47 | | | | | | |
| | D3 | | | | | | 0.58 | | |
| | D4 | | | | 0.08 | | | | |
| | D5 | | | | | | | 0.15 | 0.08 |
| | D6 | | | 0.25 | | 0.08 | | 0.13 | |
| | E1 | 4.9 | | | | | | | 2.9 |
| | E2 | | 4.8 | 7.2 | | | 17.4 | | 6.2 |
| | E3 | 10.6 | | 11.5 | | | 14.7 | | |
| | E4 | 5.47 | | | | | | 55 | |
| | E5 | | | 5 | 8.5 | | | | |
| | E6 | | | | | | | | |
| | E7 | | | | | | | | |
| | E8 | | | | | | | | |
| | E9 | | | | | | | | |
| | E10 | | | | | | | | |
| | E11 | | | | 7.2 | | | | |
| | E12 | | | | 9.5 | | | | |
| | E13 | | | | 7.2 | | | | |
| | E14 | | | | | | 8.5 | | |
| | E15 | | | | | | | | |
| | E16 | | 2.5 | | | | | | |
| | E17 | | 2.2 | | | | | 13.2 | |
| | E18 | | | | | | | 6.2 | |
| | E19 | | | | | 6.7 | | | |
| | E20 | | | | | | | | 3.8 |
| | E21 | | | | | 8.2 | | | |
| | Antioxidant F1 | 1 | | 1 | | 1 | 0.5 | | 0.2 |
| | Antioxidant F2 | | | | | 1 | 0.5 | | 0.8 |
| | Antistatic agent | 3 | | 3 | | | 2 | | 2 |

| | | | | | | | | |
|---|---|---|---|---|---|---|---|---|
| Molar ratio of C to amino groups of A | 0.00 | 0.62 | 0.86 | 0.16 | 2.25 | 0.49 | 0.72 | 4.59 |
| Total weight (parts by weight) of B and | — | 0.20 | 2.50 | 0.80 | 0.67 | 0.40 | 6.67 | 0.50 |
| B derivatives with respect to 100 parts | | | | | | | | |
| by weight of C | | | | | | | | |
| Application rate (%) of treatment agent | 0.9 | 1.1 | 1.1 | 1.0 | 1.1 | 1.0 | 0.9 | 1.0 |
| Bundling property | A | A | A | A | A | A | A | A |
| Abrasion resistance | A | B | B | B | A | A | A | A |
| Carbon fiber strength (Gpa) | 4.82 | 4.98 | 4.98 | 4.97 | 5.01 | 4.98 | 4.97 | 4.97 |

| | | Example | | | | |
|---|---|---|---|---|---|---|
| | | 79 | 80 | 81 | 82 | 83 |
| Composition of | A7 | | | 80 | | |
| non-volatile | A10 | | | | 85 | 80 |
| components | A16 | | | | | |
| (wt %) | A17 | | | | | |
| | A18 | 75 | 60 | | | |
| | B1 | | | 0.003 | | |
| | B2 | | | | | |
| | B3 | | 0.015 | 0.001 | 0.003 | |
| | B4 | | | | 0.002 | |
| | B5 | 0.01 | | | | |
| | B6 | | 0.005 | | | |
| | B7 | | | | | |
| | B8 | | | 0.001 | | |
| | B9 | | | | 0.005 | 0.01 |
| | C1 | | | | 1 | 2 |
| | C2 | | | | | |
| | C5 | | | | | |
| | C6 | | | | | |
| | C7 | | | 4 | | |
| | C8 | | | | | |
| | C9 | | 5 | | | 2 |
| | C10 | | 10 | | | |
| | D1 | | | | 0.05 | |
| | D2 | | | 0.3 | 0.09 | 0.156 |
| | D3 | | | 0.45 | 0.05 | 0.004 |
| | D4 | 0.09 | 0.78 | 0.045 | | |
| | D5 | | | | | |
| | D6 | | | | | 0.03 |
| | E1 | | | | | |
| | E2 | | | | | |
| | E3 | | | | | |
| | E4 | | | | | |
| | E5 | | | | | |
| | E6 | | | 2 | | |
| | E7 | | 6.2 | | | |
| | E8 | | | | | |
| | E9 | 5.4 | | | | |
| | E10 | | | | | |
| | E11 | 4.5 | | 3.7 | 8.1 | 2.8 |
| | E12 | 2.5 | | 2.5 | 5.7 | 11 |
| | E13 | 3 | | 2 | | 2 |
| | E14 | | 7.8 | | | |
| | E15 | 6.5 | | | | |
| | E16 | | 6.2 | | | |
| | E17 | | | | | |
| | E18 | | | | | |
| | E19 | | | | | |
| | E20 | | | | | |
| | E21 | | | | | |
| | Antioxidant F1 | 0.2 | 0.2 | 0.7 | | |
| | Antioxidant F2 | 0.8 | 0.8 | 0.3 | | |
| | Antistatic agent | 2 | 3 | 4 | | |

| | | | | | |
|---|---|---|---|---|---|
| Molar ratio of C to amino groups of A | 0.00 | 2.84 | 0.52 | 0.33 | 0.78 |
| Total weight (parts by weight) of B and | — | 0.13 | 0.13 | 1.00 | 0.25 |
| B derivatives with respect to 100 parts | | | | | |
| by weight of C | | | | | |
| Application rate (%) of treatment agent | 1.1 | 1.0 | 1.1 | 1.1 | 1.0 |
| Bundling property | A | A | A | A | A |
| Abrasion resistance | B | B | A | A | A |
| Carbon fiber strength (Gpa) | 4.81 | 4.96 | 4.95 | 4.94 | 4.99 |

TABLE 9

| | | Comparative Example | | | | | | | | | |
|---|---|---|---|---|---|---|---|---|---|---|---|
| | | 1 | 2 | 3 | 4 | 5 | 6 | 7 | 8 | 9 | 10 |
| Composition of non-volatile | A1 | 75 | 70 | | | | | | | | |
| components (wt %) | A2 | | | 80 | | | | | | | |
| | A3 | | | | 85 | 80 | 70 | | | | |
| | A4 | | | | | | | 80 | 80 | 75 | 60 |
| | A16 | | | | | | | | | | 25 |
| | B'1 | | | | | | 0.02 | | | 0.02 | |
| | B'2 | 0.007 | | | | | | | | 0.01 | |
| | B'3 | 0.003 | | | | | | | 0.03 | 0.01 | |
| | C1 | | 1.5 | 0.5 | | | | | | | |
| | C2 | 2 | | | 2 | | | | 2 | | |
| | C3 | | | | | | | | | | |
| | C4 | | | | | 5 | | | | | |
| | C5 | | | | | | | | | | 10 |
| | C6 | | | 1 | | | | | | | |
| | C8 | 3.5 | | | | | | | | | |
| | C9 | | | | | | | 10 | | 5 | |
| | D1 | | | | | | | 0.1 | | | |
| | D2 | | | | 0.2 | | | | | | |
| | D3 | 0.1 | | | 0.1 | 0.1 | 0.1 | 0.1 | 0.67 | 0.16 | 0.15 |
| | D4 | | | | | | 0.1 | | 0.3 | | |
| | D5 | 0.1 | | | | | | | | | 0.05 |
| | D6 | 0.09 | | | | 0.1 | 0.08 | | | | |
| | E1 | | | | | | | | | | 2.8 |
| | E2 | | | | 7.5 | | | 2.4 | | 5.2 | |
| | E3 | | | | 5.2 | | | | | 7.3 | |
| | E4 | | | | | | | | | | |
| | E5 | | | | | | | 2 | | | |
| | E6 | | | | | | | | | | |
| | E7 | | | 4.8 | | | | | 7.3 | | 2 |
| | E8 | 5.8 | | | | | | | | | |
| | E9 | | | | | | | | | | |
| | E10 | | | | | 4.5 | | | | 4.3 | |
| | E11 | 3.8 | | | | | | | | | |
| | E12 | | 10 | | | | 15.8 | | | | |
| | E13 | 5.6 | | | | | | | | | |
| | E15 | | | | | | 4.4 | | | | |
| | E16 | | 7.5 | | | | 4.5 | | | | |
| | E17 | | 10 | | | 4.2 | | | | | |
| | E18 | | | | | 6.1 | | | | | |
| | E19 | | | 5.7 | | | | | 4.2 | | |
| | E20 | | | | | | | 1.4 | | | |
| | E21 | | | 8 | | | | | 5.5 | | |
| | Antioxidant F1 | 0.5 | 0.3 | | | | 0.2 | 0.5 | | 0.7 | |
| | Antioxidant F2 | 0.5 | 0.7 | | | | 0.8 | 0.5 | | 0.3 | |
| | Antistatic agent | 3 | | | | | 4 | 3 | | 2 | |

| | | | | | | | | | | |
|---|---|---|---|---|---|---|---|---|---|---|
| Molar ratio of C to amino groups of A | 1.33 | 1.39 | 0.35 | 0.14 | 0.22 | 0.00 | 1.62 | 1.91 | 0.86 | 1.03 |
| Total weight (parts by weight) of B and B | 0.00 | 0.00 | 0.00 | 0.00 | 0.00 | — | 0.00 | 0.00 | 0.00 | 0.00 |
| derivatives with respect to 100 parts by | | | | | | | | | | |
| weight of C | | | | | | | | | | |
| Application rate (%) of treatment agent | 1.0 | 1.1 | 1.0 | 1.0 | 1.1 | 0.9 | 1.1 | 0.9 | 1.1 | 1.0 |
| Bundling property | C | C | C | C | C | C | C | C | C | C |
| Abrasion resistance | D | D | D | B | C | B | D | D | D | D |
| Carbon fiber strength (Gpa) | 4.72 | 4.71 | 4.72 | 4.78 | 4.75 | 4.76 | 4.75 | 4.75 | 4.75 | 4.76 |

TABLE 10

| | | Comparative Example | | | | | | | | | |
|---|---|---|---|---|---|---|---|---|---|---|---|
| | | 11 | 12 | 13 | 14 | 15 | 16 | 17 | 18 | 19 | 20 |
| Composition of non-volatile | A5 | 80 | 75 | 35 | | | | | | | |
| components (wt %) | A6 | | | | 80 | 80 | 70 | | | | |
| | A7 | | | | | | | 80 | 80 | | |
| | A8 | | | | | | | | | 80 | 80 |
| | A9 | | | | | | | | | | |
| | A10 | | | 50 | | | | | | | |
| | B′1 | | | | 0.015 | | | | | | |
| | B′2 | | | | 0.015 | | | | | | |
| | B′3 | | | | | | | | 0.05 | | |
| | C1 | 5 | | | | | | | | | |
| | C6 | | | 3 | | | | | | 2 | |
| | C7 | | 2 | | | | | 4 | | 1 | |
| | C8 | | | | | | | | | | |
| | C9 | | | | 4.5 | | | | 3 | | |
| | C10 | | | | | | 3 | | | | |
| | D1 | | | | 0.07 | | | | | 0.1 | |
| | D2 | | | | | | | 0.3 | | | |
| | D3 | | | 0.1 | | | | 0.5 | 0.15 | | |
| | D4 | | | | | | 0.1 | 0.1 | | | |
| | D5 | 0.5 | | | | | | | | | |
| | D6 | | | | | | | | 0.1 | | |
| | E1 | | | | 2.7 | | | | | 3.3 | |
| | E2 | | | 5.3 | | 12.5 | | | | | |
| | E3 | | | | | 6.5 | | | | | |
| | E4 | | | | | | | | | | |
| | E5 | | | | | | | | | | |
| | E6 | | | | | | 8.9 | 2 | | | |
| | E7 | | | | | | 7.6 | | 2 | | |
| | E8 | | | | | | | | | | |
| | E9 | | | | | | | | | 4 | |
| | E10 | | | | | | | | | | |
| | E11 | 2 | 2.6 | | | | | 3.6 | | | |
| | E12 | | 7.4 | | | | | 2.5 | | | |
| | E13 | 7.8 | 4 | | | | | 2 | | 3.5 | |
| | E14 | | | | | | 10.4 | | | | |
| | E15 | | 6 | | | | | | | | |
| | E16 | 4.7 | | | 7.4 | | | | | | |
| | E17 | | | | | | | | | | 4.4 |
| | E18 | | | | | | | | | 6.1 | 10.6 |
| | E19 | | | | | | | | 4.7 | | |
| | E20 | | | 2.6 | 5.3 | | | | | | |
| | E21 | | | | | | | | 6 | | |
| | Antioxidant F1 | | 1 | 1 | | 1 | | 0.7 | 0.2 | | 1 |
| | Antioxidant F2 | | | | | | | 0.3 | 0.8 | | |
| | Antistatic agent | | 2 | 3 | | | | 4 | 3 | | 4 |

| | | | | | | | | | | |
|---|---|---|---|---|---|---|---|---|---|---|
| Molar ratio of C to amino groups of A | 1.77 | 0.06 | 0.12 | 0.58 | 0.00 | 0.27 | 0.52 | 0.49 | 0.13 | 0.00 |
| Total weight (parts by weight) of B and B | 0.00 | 0.00 | 0.00 | 0.00 | — | 0.00 | 0.00 | 0.00 | 0.00 | — |
| derivatives with respect to 100 parts by | | | | | | | | | | |
| weight of C | | | | | | | | | | |
| Application rate (%) of treatment agent | 1.0 | 1.1 | 1.0 | 0.9 | 1.0 | 1.0 | 1.1 | 0.9 | 1.0 | 1.0 |
| Bundling property | C | C | C | C | C | C | C | C | C | C |
| Abrasion resistance | D | D | D | D | D | D | D | D | B | B |
| Carbon fiber strength (Gpa) | 4.75 | 4.75 | 4.75 | 4.76 | 4.76 | 4.76 | 4.75 | 4.75 | 4.76 | 4.76 |

TABLE 11

| | | Comparative Example | | | | | | | | | |
|---|---|---|---|---|---|---|---|---|---|---|---|
| | | 21 | 22 | 23 | 24 | 25 | 26 | 27 | 28 | 29 | 30 |
| Composition of non-volatile | A8 | 75 | | | | | | | | | |
| components (wt %) | A9 | | 80 | 65 | | | | | | | |
| | A10 | | | | 80 | 80 | 75 | 55 | | | |
| | A11 | | | | | | | | 90 | | |
| | A12 | | | | | | | | | 75 | |
| | A13 | | | | | | | | | | 85 |
| | A14 | | | | | | | | | | |
| | A15 | | | | | | | 20 | | | |
| | BM1 | | | | | | | | | | 0.01 |
| | B′2 | | | 0.012 | | | 0.05 | | | | 0.01 |
| | B′3 | | | 0.018 | | | | | | | |
| | C1 | 3 | | | 1 | | | | | | 2 |
| | C2 | | 5 | 1 | | | | | | | |
| | C3 | | | | | | | 2 | | | |
| | C4 | | | | | | | | | | |
| | C5 | | | | | | 3 | | | 10 | |
| | C6 | | | | | | | | 5 | | |
| | C9 | | | 25 | 5 | | | | | | |
| | C10 | | | | | 10 | | | | | |
| | D1 | | | | | | | | 0.1 | | |
| | D2 | | | 0.07 | | | | | | | 0.1 |
| | D3 | 0.9 | | 0.1 | | 0.1 | | | | | 0.08 |
| | D4 | | | | | | 0.15 | | | | |
| | D5 | | | | | 0.1 | | | | | |
| | D6 | | | | | | | | 0.1 | | |
| | E1 | | | | | | | 2.6 | | | |
| | E2 | | | | | | | 5.2 | | 3.5 | |
| | E3 | | | | | | | 7.3 | | | |
| | E4 | | | | | | | | 4.8 | | |
| | E5 | | | | | | | | | | |
| | E6 | | | | | | | 3.9 | | | |
| | E7 | | | | | | | | | | |
| | E8 | | | | | | 6 | | | | |
| | E9 | | | | | | | | | | |
| | E10 | | | | | | | | | | |
| | E11 | | | 7.8 | 6.7 | 1.8 | | | | | 3.5 |
| | E12 | | | | 6.3 | | | | | | |
| | E13 | | | 1 | 1 | 8 | | | | 4.3 | 6.3 |
| | E14 | | | | | | | | | | |
| | E15 | | | | | | | | | | |
| | E16 | | | | | | | | | | |
| | E17 | 13.5 | 3.9 | | | | 2.5 | | | | |
| | E18 | 4.6 | 7.1 | | | | 5.5 | | | | |
| | E19 | | | | | | | | | 3.2 | |
| | E20 | | | | | | | | | | |
| | E21 | | | | | | 6.8 | | | | |
| | Antioxidant F1 | 1 | 1 | | | | 0.2 | 0.2 | | | 0.5 |
| | Antioxidant F2 | | | | | | 0.8 | 0.8 | | 1 | 0.5 |
| | Antistatic agent | 2 | 3 | | | | | 3 | | 3 | 2 |

| | | | | | | | | | | |
|---|---|---|---|---|---|---|---|---|---|---|
| Molar ratio of C to amino groups of A | 1.33 | 2.42 | 3.12 | 0.54 | 0.22 | 0.15 | 0.29 | 0.42 | 1.21 | 1.57 |
| Total weight (parts by weight) of B and B | 0.00 | 0.00 | 0.00 | 0.00 | 0.00 | 0.00 | 0.00 | 0.00 | 0.00 | 0.00 |
| derivatives with respect to 100 parts by | | | | | | | | | | |
| weight of C | | | | | | | | | | |
| Application rate (%) of treatment agent | 1.1 | 1.0 | 0.9 | 1.0 | 1.1 | 1.0 | 0.9 | 1.0 | 1.1 | 1.0 |
| Bundling property | C | C | C | C | C | C | C | C | C | C |
| Abrasion resistance | C | D | D | D | D | D | D | D | D | D |
| Carbon fiber strength (Gpa) | 4.77 | 4.76 | 4.75 | 4.76 | 4.76 | 4.76 | 4.76 | 4.74 | 4.76 | 4.73 |

TABLE 12

| | | Comparative Example | | | | | | | | | |
|---|---|---|---|---|---|---|---|---|---|---|---|
| | | 31 | 32 | 33 | 34 | 35 | 36 | 37 | 38 | 39 | 40 |
| Composition of non-volatile | A13 | 80 | 75 | | | | | | | | |
| components (wt %) | A14 | | | 80 | | | | | | | |
| | A15 | | | | 85 | | | | | | |
| | A16 | | | | | 75 | 70 | 65 | | | |
| | A17 | | | | | | | | 80 | 50 | |
| | A18 | | | | | | | | | | 75 |
| | BM1 | | | | 0.006 | | | | | | |
| | B′2 | | | | 0.005 | | | | | | 0.003 |
| | B′3 | | | | 0.009 | | | | | | 0.007 |
| | C1 | | | | | | 2 | | 3 | | |
| | C2 | 1 | | 0.1 | 5 | | | | | | |
| | C3 | | | | | | | | | | |
| | C4 | | 3.5 | | | | | | | | |
| | C5 | | | | | | | 2.5 | | | |
| | C6 | | | | | | | | | | |
| | C7 | | | | | | | | | 5 | |
| | D1 | | | | | | 0.1 | | | 0.8 | |
| | D2 | | | | | | | | | | |
| | D3 | | | | 0.09 | | | | | 0.7 | |
| | D4 | | 0.1 | | | | | | | | 0.09 |
| | D5 | | | | 0.09 | | | | | | |
| | D6 | | | | | | 0.1 | | | | |
| | E1 | | 5.6 | | 4.1 | 4.9 | | | | | |
| | E2 | | 10.7 | | | | 7.2 | | | 17.4 | |
| | E3 | | | | | 10.6 | 11.5 | | | 14.6 | |
| | E4 | | 5.1 | | | 5.5 | | | | | |
| | E5 | | | | | | 5.1 | 8.5 | | | |
| | E6 | | | | | | | | | | |
| | E7 | | | | | | | | | | |
| | E8 | 5.9 | | | | | | | | | |
| | E9 | | | | | | | | | | 5.4 |
| | E10 | | | | | | | | | | |
| | E11 | | | 7.4 | 2.5 | | | 7.2 | | | 4.5 |
| | E12 | | | 9.2 | | | | 9.6 | | | 2.5 |
| | E13 | | | 3.3 | | | | 7.2 | | | 3 |
| | E14 | | | | | | | | | 8.5 | |
| | E15 | | | | | | | | | | 6.5 |
| | E18 | 5.7 | | | | | | | | | |
| | E19 | | | | | | | | 6.8 | | |
| | E20 | 4.4 | | | | | | | | | |
| | E21 | | | | 3.2 | | | | 8.2 | | |
| | Antioxidant F1 | 0.6 | | | | 1 | 1 | | 1 | 0.5 | 0.2 |
| | Antioxidant F2 | 0.4 | | | | | | | 1 | 0.5 | 0.8 |
| | Antistatic agent | 2 | | | | 3 | 3 | | | 2 | 2 |

| | | | | | | | | | | |
|---|---|---|---|---|---|---|---|---|---|---|
| Molar ratio of C to amino groups of A | 0.51 | 1.07 | 0.11 | 0.48 | 0.00 | 0.86 | 0.16 | 2.25 | 0.49 | 0.00 |
| Total weight (parts by weight) of B and B | 0.00 | 0.00 | 0.00 | 0.00 | — | 0.00 | 0.00 | 0.00 | 0.00 | — |
| derivatives with respect to 100 parts by | | | | | | | | | | |
| weight of C | | | | | | | | | | |
| Application rate (%) of treatment agent | 0.9 | 1.0 | 1.1 | 1.0 | 0.9 | 1.1 | 1.0 | 1.1 | 1.0 | 1.1 |
| Bundling property | C | C | C | C | C | C | C | C | C | C |
| Abrasion resistance | D | D | D | D | B | B | C | D | D | D |
| Carbon fiber strength (Gpa) | 4.73 | 4.73 | 4.72 | 4.72 | 4.76 | 4.76 | 4.76 | 4.77 | 4.76 | 4.75 |

As is apparent from Tables 1 to 12, it is found that the treatment agents for acrylic fibers of the examples are better in bundling property in the process for producing acrylic fibers for carbon fiber production and the step for enhancing flame resistance than the treatment agents of the comparative examples in which the amino-modified silicone (A) and/or the compound (B) are not contained, and high-quality carbon fibers can be obtained.

1. A treatment agent for acrylic fibers, comprising: an amino-modified silicone (A); and at least one selected from a compound (B) having a five-membered ring structure containing a sulfur atom and a nitrogen atom and a derivative of the compound (B).

2. The treatment agent for acrylic fibers according to claim 1, wherein the compound (B) contains at least one selected from a compound represented by Formula (1) below and a compound represented by Formula (2) below: 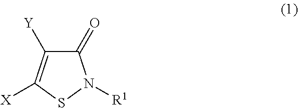
In Formula (1), R¹ is an alkyl group having 1 to 12 carbon atoms, an aralkyl group, or a hydrogen atom, and X and Y are independently a hydrogen atom or a halogen atom, 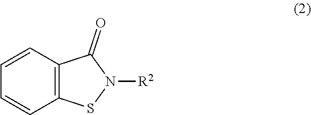
in Formula (2), R² is an alkyl group having one to eight carbon atoms or a hydrogen atom.

3. The treatment agent for acrylic fibers according to claim 1, further comprising a Bronsted acid compound (C).

4. The treatment agent for acrylic fibers according to claim 3, wherein the Bronsted acid compound (C) contains at least one selected from a carboxylic acid compound, an inorganic acid, a sulfonic acid compound, a phosphate ester compound, a sulfate ester compound, and a phosphonic acid compound.

5. The treatment agent for acrylic fibers according to claim 3, wherein a molar ratio of the Bronsted acid compound (C) to amino groups of the amino-modified silicone (A) is 0.01 to 5.0.

6. The treatment agent for acrylic fibers according to claim 3, wherein a total weight of the compound (B) and the derivative of the compound (B) is 0.01 to 50 parts by weight with respect to 100 parts by weight of the Bronsted acid compound (C).

7. The treatment agent for acrylic fibers according to claim 1, further comprising a hydrophilic solvent (D), wherein the hydrophilic solvent (D) contains at least one selected from a compound represented by Formula (3) below and an aprotic nitrogen-containing organic compound: 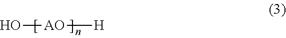
in Formula (3), AO is an oxyalkylene group having two to four carbon atoms, and n is an integer of one to three.

8. The treatment agent for acrylic fibers according to claim 1, wherein a weight ratio of the amino-modified silicone (A) to a non-volatile content of the treatment agent is 20 to 90 wt %.

9. The treatment agent for acrylic fibers according to claim 1, further comprising a nonionic surfactant (E).

10. An acrylic fiber for carbon fiber production, comprising the treatment agent for acrylic fibers according to claim 1 attached to a raw material acrylic fiber of the acrylic fiber for carbon fiber production.

11. A method for producing a carbon fiber, the method comprising: a flame resistance enhancing treatment step of converting the acrylic fiber for carbon fiber production according to claim 10 into a flame resistant fiber in an oxidizing atmosphere at 200 to 300° C.; and a carbonization treatment step of further carbonizing the flame resistant fiber in an inert atmosphere at 300 to 2,000° C.

12. The treatment agent for acrylic fibers according to claim 2, further comprising a Bronsted acid compound (C).

13. The treatment agent for acrylic fibers according to claim 12, wherein the Bronsted acid compound (C) contains at least one selected from a carboxylic acid compound, an inorganic acid, a sulfonic acid compound, a phosphate ester compound, a sulfate ester compound, and a phosphonic acid compound.

14. The treatment agent for acrylic fibers according to claim 4, wherein a molar ratio of the Bronsted acid compound (C) to amino groups of the amino-modified silicone (A) is 0.01 to 5.0.

15. The treatment agent for acrylic fibers according to claim 12, wherein a molar ratio of the Bronsted acid compound (C) to amino groups of the amino-modified silicone (A) is 0.01 to 5.0.

16. The treatment agent for acrylic fibers according to claim 12, wherein a total weight of the compound (B) and the derivative of the compound (B) is 0.01 to 50 parts by weight with respect to 100 parts by weight of the Bronsted acid compound (C).

17. The treatment agent for acrylic fibers according to claim 2, further comprising a hydrophilic solvent (D), wherein the hydrophilic solvent (D) contains at least one selected from a compound represented by Formula (3) below and an aprotic nitrogen-containing organic compound: 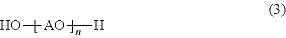
in Formula (3), AO is an oxyalkylene group having two to four carbon atoms, and n is an integer of one to three.

18. The treatment agent for acrylic fibers according to claim 2, wherein a weight ratio of the amino-modified silicone (A) to a non-volatile content of the treatment agent is 20 to 90 wt %.

19. The treatment agent for acrylic fibers according to claim 2, further comprising a nonionic surfactant (E).

20. An acrylic fiber for carbon fiber production, comprising the treatment agent for acrylic fibers according to claim 2 attached to a raw material acrylic fiber of the acrylic fiber for carbon fiber production.
